(19) United States
(12) Patent Application Publication
(10) Pub. No.: US 2026/0326072 A1
(43) Pub. Date: Oct. 22, 2026

(54) SYSTEMS AND METHODS FOR MODULATING REACTING FLOWS

(71) Applicant: MONOLITH MATERIALS, INC., Lincoln, NE (US)

(72) Inventors: Mathew Leis, Lincoln, NE (US); Markus Finkbeiner, Lincoln, NE (US); Alexander Hoermann, Lincoln, NE (US)

(73) Assignee: MONOLITH MATERIALS, INC., Lincoln, NE (US)

(21) Appl. No.: 19/123,020

(22) PCT Filed: Oct. 20, 2023
(86) PCT No.: PCT/US2023/077402

§ 371 Date: Apr. 21, 2025

Related U.S. Application Data
(60) Provisional application No. 63/418,357, filed on Oct. 21, 2022.
(60) Provisional application No. 63/468,989, filed on May 25, 2023.

(51) Int. Cl. B01J 19/08; C01B 32/05; H05H 1/00; H05H 1/48

(52) U.S. Cl. CPC B01J 19/088; C01B 32/05; H05H 1/01; H05H 1/48; B01J 2219/00164; B01J 2219/0869; B01J 2219/0871; B01J 2219/0896

(57) ABSTRACT

The present disclosure provides systems and methods for modulating reacting flows. Systems described herein may include a plasma generating section, a carbon particle generating section, and an obstacle located between the plasma generating section and the carbon particle generating section. The obstacle may be configured to contact a fluid flowing from the plasma generating section to the carbon generating section and thereby reduce angular momentum of the fluid. The obstacle may alter fluid flow such that a ratio of angular momentum to linear momentum of the gas is less than about 1.5. The obstacle may reduce fouling of the system as compared to a system without the obstacle. Methods described herein may use the systems described herein to modulate reacting flows.

### CROSS-REFERENCE

This application is related to and claims the benefit of priority under 35 U.S.C. § 119(e) from U.S. Provisional Patent Application No. 63/418,357, filed Oct. 21, 2022, and U.S. Provisional Patent Application No. 63/468,989, filed May 25, 2023, the disclosure of which is expressly incorporated herein by reference in entirety.

### BACKGROUND

Various chemical processes involve the flow of various reactants, including hot gas, for example, plasma gas, hydrogen, argon, carbon monoxide, carbon dioxide, nitrogen, and/or krypton, to name but a few. Energy supply, production performance, and environmental performance associated with such chemical processes have evolved over time. Yet such chemical processes may involve turbulent flow regimes with insufficient modulation of reacting flows, resulting in unwanted, inefficient, and costly solids deposition, reactor fouling, and/or the like.

### SUMMARY

The present disclosure provides systems and methods for increasing time of flight of reactants within a reactor. Such systems and methods may reduce contact of reactants and reaction products with reactor walls to thereby reduce fouling of the reactor.

In an aspect, the present disclosure provides an apparatus for making carbon particles. The apparatus may comprise a plasma generating section, a carbon particle generating section, and an obstacle disposed between the plasma generating section and the carbon particle generating section, wherein the obstacle is configured to contact, during use, a fluid flowing from the plasma generating section to the carbon particle generating section, thereby reducing angular momentum of the fluid.

In some embodiments, the plasma generating section comprises one or more plasma generating electrodes. In some embodiments, the plasma generating electrodes are configured to heat a thermal transfer gas in the plasma generating section. In some embodiments, the carbon particle generating section comprises one or more hydrocarbon injectors. In some embodiments, the injectors are configured to inject a hydrocarbon feedstock into the carbon particle generating section.

In some embodiments, the obstacle is configured to be static when contacting the fluid. In some embodiments, the apparatus comprises a throat section that is narrower than the plasma generating section or the carbon particle generating section. In some embodiments, the throat section is located between the plasma generating section and the carbon particle generating section. In some embodiments, the obstacle is located in the throat section. In some embodiments, the obstacle is located at or near an entrance to or an exit of the throat section. In some embodiments, the obstacle comprises a flat surface. In some embodiments, the obstacle comprises a curved surface. In some embodiments, the obstacle comprises a plate. In some embodiments, a surface of the obstacle is positioned perpendicular to a flow path of the fluid.

In some embodiments, the obstacle comprises a plurality of members. In some embodiments, a first member contacts a second member. In some embodiments, first and second members make contact at a center axis of the apparatus. In some embodiments, two or more members are interlocked with one another. In some embodiments, the members are interlocked with one another in a lattice. In some embodiments, the members are oriented randomly with respect to one another. In some embodiments, the members are radially positioned with respect to one another. In some embodiments, the obstacle comprises a porous structure. In some embodiments, the porous structure comprises a molecular sieve or a sponge diffuser. In some embodiments, pores of the porous structure are visible to a human eye. In some embodiments, the obstacle is configured to reduce bulk flow momentum of a fluid flowing from the plasma generating section to the carbon particle generating section.

In another aspect, the present disclosure provides a method for making carbon particles. The method may comprise providing an apparatus comprising (i) a plasma generating section, (ii) a carbon particle generating section, and (iii) an obstacle located between the plasma generating section and the carbon particle generating section; flowing a thermal transfer gas from the plasma generating section to the carbon particle generating section such that the thermal transfer gas contacts the obstacle, wherein contact of the thermal transfer gas with the obstacle reduces angular momentum of the thermal transfer gas; and in the carbon particle generating section, using the thermal transfer gas to generate the carbon particles.

In some embodiments, the obstacle comprises a flat surface. In some embodiments, the obstacle comprises a curved surface. In some embodiments, the obstacle comprises a plate. In some embodiments, a surface of the obstacle is positioned perpendicular to a flow path of the thermal transfer gas. In some embodiments, the obstacle comprises a plurality of members. In some embodiments, a first member contacts a second member. In some embodiments, first and second members make contact at a center axis of the apparatus. In some embodiments, two or more members are interlocked with one another. In some embodiments, the members are interlocked with one another in a lattice. In some embodiments, members are oriented randomly with respect to one another. In some embodiments, members are radially positioned with respect to one another. In some embodiments, the obstacle comprises a porous structure. In some embodiments, the porous structure comprises a molecular sieve. In some embodiments, pores of the porous structure are visible to a human eye.

In some embodiments, the obstacle reduces angular momentum of the thermal transfer gas by at least about 50%. In some embodiments, the obstacle reduces angular momentum of the thermal transfer gas by at least about 90%. In some embodiments, a ratio of angular momentum of the thermal transfer gas to linear momentum of the thermal transfer gas is less than about 1.5 prior to the thermal transfer gas entering the carbon particle generating section. In some embodiments, a ratio of angular momentum of the thermal transfer gas to linear momentum of the thermal transfer gas is less than about 1 prior to the thermal transfer gas entering the carbon particle generating section. In some embodiments, the thermal transfer gas is contacted with a hydrocarbon feedstock in the carbon particle generating section. In embodiments, less than about 25%, 15%, 10%, or 5% of the hydrocarbon feedstock fouls the carbon particle generating section.

In another aspect, the present disclosure provides a method for making carbon particles. The method may comprise providing an apparatus comprising (i) a plasma generating section and (ii) a carbon particle generating section; flowing a thermal transfer gas from the plasma generating section to the carbon particle generating section such that angular momentum of the thermal transfer gas is reduced by at least about 50% prior to entering the carbon particle generating section; and in the carbon particle generating section, using the thermal transfer gas to generate the carbon particles.

In some embodiments, the angular momentum of the thermal transfer gas is reduced by at least about 75%. In some embodiments, the angular momentum of the thermal transfer gas is reduced by at least about 90%. In some embodiments, the thermal transfer gas is contacted with a hydrocarbon feedstock in the carbon particle generating section. In embodiments, less than about 25%, 15%, 10%, or 5% of the hydrocarbon feedstock fouls the carbon particle generating section. In some embodiments, a ratio of angular momentum of the thermal transfer gas to linear momentum of the thermal transfer gas is less than about 1.5 prior to the thermal transfer gas entering the carbon particle generating section. In some embodiments, the method further comprises flowing the thermal transfer gas from the plasma generating section to the carbon particle generating section such that the thermal transfer gas contacts the obstacle prior to using the thermal transfer gas to generate the carbon particles.

In another aspect, the present disclosure provides a method for making carbon particles. The method may comprise providing an apparatus comprising (i) a plasma generating section and (ii) a carbon particle generating section; flowing a thermal transfer gas from the plasma generating section to the carbon particle generating section, wherein a ratio of angular momentum of the thermal transfer gas to linear momentum of the thermal transfer gas is less than about 1.5 prior to the thermal transfer gas entering the carbon particle generating section; and in the carbon particle generating section, using the thermal transfer gas to generate the carbon particles.

In some embodiments, a ratio of angular momentum of the thermal transfer gas to linear momentum of the thermal transfer gas is less than about 1.25 prior to the thermal transfer gas entering the carbon particle generating section. In some embodiments, a ratio of angular momentum of the thermal transfer gas to linear momentum of the thermal transfer gas is less than about 1 prior to the thermal transfer gas entering the carbon particle generating section. In some embodiments, the thermal transfer gas is contacted with a hydrocarbon feedstock in the carbon particle generating section to generate the carbon particles. In some embodiments, less than about 25%, 15%, 10%, or 5% of the hydrocarbon feedstock fouls the carbon particle generating section.

In another aspect, the present disclosure provides a method for making carbon particles. The method may comprise providing an apparatus comprising (i) a plasma generating section and (ii) a carbon particle generating section; flowing a thermal transfer gas from the plasma generating section to the carbon particle generating section; and in the carbon particle generating section, contacting the thermal transfer gas with a hydrocarbon feedstock to generate the carbon particles, wherein less than about 25% of the hydrocarbon feedstock fouls the carbon particle generating section. In some embodiments, less than about 20%, 15%, 10%, or 5% of the hydrocarbon feedstock fouls the carbon particle generating section.

In another aspect, the present disclosure provides a method for making carbon particles. The method may comprise providing an apparatus comprising (i) a plasma generating section and (ii) a carbon particle generating section; flowing a thermal transfer gas with a first angular momentum from the plasma generating section to the carbon particle generating section, wherein the first angular momentum has a first magnitude and a first direction; contacting the thermal transfer gas with a fluid with a second angular momentum, wherein the second angular momentum has a second magnitude and a second direction, and wherein contact of the thermal transfer gas with the fluid reduces the first magnitude in the first direction of the first angular momentum; and in the carbon particle generating section, using the thermal transfer gas to generate the carbon particles.

In some embodiments, the second direction of the second angular momentum opposes the first direction of the first angular momentum. In some embodiments, the first magnitude is greater than the second magnitude. In some embodiments, a ratio of the first magnitude to the second magnitude is greater than about 1. In some embodiments, a ratio of the first magnitude to the second magnitude is in a range of about 1 to about 5. In some embodiments, a ratio of the first magnitude to the second magnitude is in a range of about 1 to about 3. In some embodiments, a ratio of the first magnitude to the second magnitude is in a range of about 1 to about 2. In some embodiments, the fluid is a hydrocarbon feedstock. In some embodiments, contacting the thermal transfer gas with the hydrocarbon feedstock generates the carbon particles. In some embodiments, the thermal transfer gas is contacted with the fluid in the carbon particle generating section. In some embodiments, the thermal transfer gas is contacted with the fluid prior to generating the carbon particles. In some embodiments, the thermal transfer gas is contacted with the fluid simultaneously with generating the carbon particles.

Additional aspects and advantages of the present disclosure will become readily apparent to those skilled in this art from the following detailed description, wherein only illustrative embodiments of the present disclosure are shown and described. As will be realized, the present disclosure is capable of other and different embodiments, and its several details are capable of modifications in various obvious respects, all without departing from the disclosure. Accordingly, the drawings and description are to be regarded as illustrative in nature, and not as restrictive.

### INCORPORATION BY REFERENCE

All publications, patents, and patent applications mentioned in this specification are herein incorporated by reference to the same extent as if each individual publication, patent, or patent application was specifically and individually indicated to be incorporated by reference. To the extent publications and patents or patent applications incorporated by reference contradict the disclosure contained in the specification, the specification is intended to supersede and/or take precedence over any such contradictory material.

### BRIEF DESCRIPTION OF THE DRAWINGS

The novel features of the invention are set forth with particularity in the appended claims. A better understanding of the features and advantages of the present disclosure will be obtained by reference to the following detailed description that sets forth illustrative embodiments, in which the principles of the present disclosure are utilized, and the accompanying drawings (also “figure” and “FIG.” herein), of which:

FIG. 1 shows a schematic representation of an example system with which one or more embodiments of the present disclosure may be disposed or used;

FIG. 2 shows an example graph of Swirl Number as a function of average reactor cleanout (fouling) as mass percent of total injected feedstock for various injector configurations without the benefit of the systems and methods of the present disclosure;

FIG. 3 shows a schematic representation of flows before and after an obstacle according to one or more embodiments of the present disclosure.

FIG. 4 shows a side-view example obstacle configuration comprising intersecting plates, according to one or more embodiments of the present disclosure;

FIG. 5 shows a side-view example obstacle configuration comprising a grid of interlocking plates, according to one or more embodiments of the present disclosure;

FIG. 6 shows a side-view example obstacle configuration comprising a series of plates, according to one or more embodiments of the present disclosure;

FIGS. 7A-7D show example top-view obstacle configurations, each according to one or more embodiments of the present disclosure; FIG. 7A shows an example obstacle configuration comprising two interlocking plates; FIG. 7B shows an example obstacle configuration comprising four interlocking plates; FIG. 7C shows an example obstacle configuration comprising six interlocking plates; FIG. 7D shows an example obstacle configuration comprising eight interlocking plates;

FIGS. 8A-8D show example top-view obstacle configurations, each according to one or more embodiments of the present disclosure; FIG. 8A shows an example obstacle configuration comprising three radially intersecting plates; FIG. 8B shows an example obstacle configuration comprising three non-intersecting plates; FIG. 8C shows an example obstacle configuration comprising a grid of three interlocking plates; FIG. 8D shows an example obstacle configuration comprising a grid of six interlocking plates;

FIG. 9 shows an example latticework structure according to one or more embodiments of the present disclosure;

FIGS. 10A and 10B show top-view example injector configurations, each according to one or more embodiments of the present disclosure; FIG. 10A shows an example injector configuration comprising injectors disposed at an outer circumference of a reactor; FIG. 10B shows an example injector configuration comprising injectors disposed within a reactor chamber; and

FIG. 11 shows an example of a computer system that is programmed or otherwise configured to implement any of the methods provided herein.

### DETAILED DESCRIPTION

While various embodiments of the present disclosure have been shown and described herein, those skilled in the art will understand that such embodiments are provided by way of example only. Numerous variations, changes, and substitutions may occur to those skilled in the art without departing from the present disclosure. It should be understood that various alternatives to the embodiments described herein may be employed.

Whenever the term “at least,” “greater than,” or “greater than or equal to” precedes the first numerical value in a series of two or more numerical values, the term “at least,” “greater than,” or “greater than or equal to” applies to each of the numerical values in that series of numerical values. For example, greater than or equal to 1, 2, or 3 is equivalent to greater than or equal to 1, greater than or equal to 2, or greater than or equal to 3.

Whenever the term “no more than,” “less than,” or “less than or equal to” precedes the first numerical value in a series of two or more numerical values, the term “no more than,” “less than,” or “less than or equal to” applies to each of the numerical values in that series of numerical values. For example, less than or equal to 3, 2, or 1 is equivalent to less than or equal to 3, less than or equal to 2, or less than or equal to 1.

Certain embodiments herein contemplate numerical ranges. When ranges are present, the ranges include the range endpoints. Additionally, every sub range and value within the range is present as if explicitly written out. The term “about” or “approximately” may mean within an acceptable error range for the particular value, which will depend in part on how the value is measured or determined, e.g., the limitations of the measurement system. For example, “about” may mean within one or more than one standard deviation, per the practice in the art. Alternatively, “about” may mean a range of up to 20%, up to 10%, up to 5%, or up to 1% of a given value. Where particular values are set forth herein, unless otherwise stated, it may be assumed that the term “about” means within an acceptable error range for the particular value.

As used herein, the term “carbon particle” may refer to a particle comprising carbon. Examples of carbon particles include, but are not limited to, carbon black, coke, needle coke, graphite, large ring polycyclic aromatic hydrocarbons, activated carbon, or the like, or any combination thereof. Carbon particles may be classified into grades. The carbon particles of the present disclosure may be of any grade.

In an aspect, the present disclosure provides systems for generating carbon particles. Systems may include apparatuses comprising a plasma generating section, a carbon particle generating section, and an obstacle located between the plasma generating section and the carbon particle generating section.

In another aspect, the present disclosure provides an apparatus for making carbon particles. The apparatus may comprise a plasma generating section, a carbon particle generating section, and an obstacle disposed between the plasma generating section and the carbon particle generating section. During use, the obstacle may contact a fluid flowing from the plasma generating section to the carbon particle generating section. The obstacle contacting the fluid may reduce angular momentum of the fluid. Reducing the angular momentum of the fluid may increase time of flight of the fluid and reduce reactor fouling as compared to an apparatus without the obstacle.

In another aspect, the present disclosure provides a method for making carbon particles. The method may comprise providing an apparatus comprising a plasma generating section, a carbon particle generating section, and an obstacle disposed between the plasma generating section and the carbon particle generating section. The method may further comprise flowing a thermal transfer gas from the plasma generating section to the carbon particle generating section such that the thermal transfer gas contacts the obstacle. Contacting the thermal transfer gas with the obstacle may reduce angular momentum of the thermal transfer gas. The method may further comprise, in the carbon particle generating section, using the thermal transfer gas to generate the carbon particles. By reducing the angular momentum of the thermal transfer gas, the time of flight of the thermal transfer gas may be increased and reactor fouling may be decreased as compared to an apparatus without the obstacle.

In another aspect, the present disclosure provides a method for making carbon particles. The method may comprise providing an apparatus comprising a plasma generating section and a carbon particle generating section. The method may further comprise flowing a thermal transfer gas from the plasma generating section to the carbon particle generating section such that angular momentum of the thermal transfer gas is reduced by at least about fifty percent prior to the thermal transfer gas entering the carbon particle section. The method may further comprise, in the carbon particle generating section, using the thermal transfer gas to generate the carbon particles.

In another aspect, the present disclosure provides a method for making carbon particles. The method may comprise providing an apparatus comprising a plasma generating section and a carbon particle generating section. The method may further comprise flowing a thermal transfer gas from the plasma generating section to the carbon particle generating section. The thermal transfer gas may have a ratio of angular momentum to linear momentum that is less than or equal to about 1.5 prior to entering the carbon particle generating section. The method may further comprise, in the carbon particle generating section, using the thermal transfer gas to generate the carbon particles.

In another aspect, the present disclosure provides a method for making carbon particles. The method may comprise providing an apparatus comprising a plasma generating section and a carbon particle generating section. The method may further comprise flowing a thermal transfer gas from the plasma generating section to the carbon particle generating section and, in the carbon particle generating section, contacting the thermal transfer gas with a hydrocarbon feedstock to generate the carbon particles. While generating the carbon particles, less than or equal to about 25% of the hydrocarbon feedstock may foul the carbon particle generating section.

In another aspect, the present disclosure provides a method for making carbon particles. The method may comprise providing an apparatus comprising a plasma generating section and a carbon particle generating section. The method may further comprise flowing a thermal transfer gas with a first angular momentum from the plasma generating section to the carbon particle generating section. The first angular momentum may have a first magnitude and a first direction. The method may further comprise contacting the thermal transfer gas with a fluid with a second angular momentum. The second angular momentum may have a second magnitude and a second direction. Contacting the thermal transfer gas with the fluid may reduce the first magnitude in the first direction of the first angular momentum. The method may further comprise, in the carbon particle generating section, using the thermal transfer gas to generate the carbon particles.

### Example System for Use

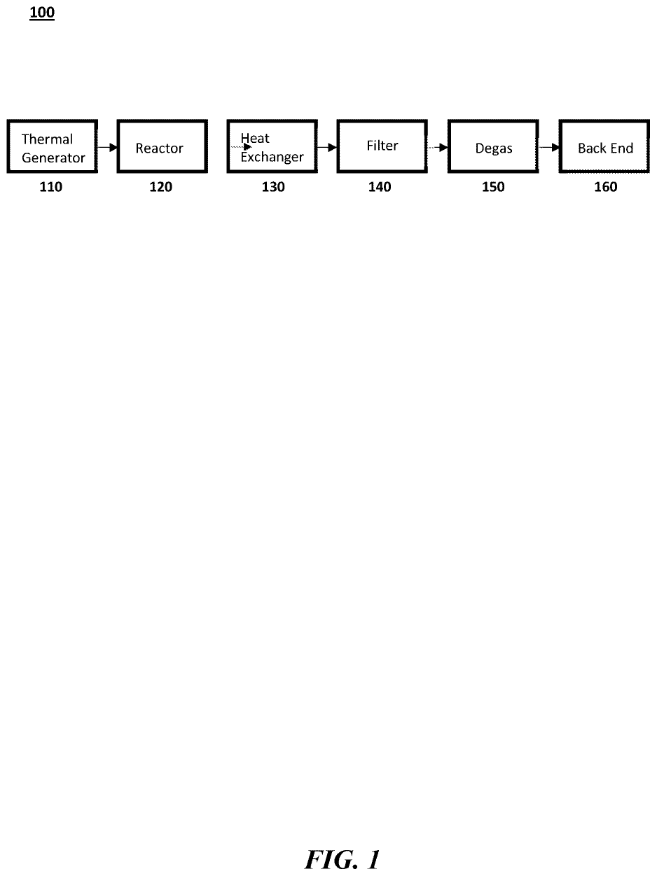

FIG. 1 shows a schematic representation of an example system 100 with which one or more embodiments of the present disclosure may be disposed or used. The system may include a thermal generator (e.g., a plasma generator) 110. The thermal generator 110 may heat at least a subset of one or more gases (e.g., a feedstock) at suitable reaction conditions in a reactor (or furnace) 120 to effect removal of a chemical (e.g., hydrogen) from the feedstock. The reactor 120 may contain the thermal generator (e.g., a plasma generator) 110. Heating (e.g., electrical heating, such as, for example, plasma heating) and reaction may be implemented in one chamber (e.g., “single chamber,” “single stage reactor” or “single stage process” herein) or multiple chambers (e.g., “dual chamber,” “dual stage reactor,” “dual stage process,” “multiple chamber,” “multiple stage reactor,” “multiple stage process,” “multi-chamber,” multi-stage reactor,” “multi-stage process,” or the like). The reactor 120 may comprise one or more constant diameter regions/sections, one or more converging regions/sections, one or more diverging regions/sections, one or more additional components, or any combination thereof. Such regions/sections, or additional components, may be combined in various ways to implement the heating and reaction in accordance with the present disclosure. For example, the reactor may have a substantially constant diameter (e.g., at least about 70%, 80%, 90%, 95% or 99% of the reactor's length may be of a constant diameter). Alternatively, or in addition, the reactor may have multiple sections, such as a first section and a second section, separated by a narrowing or a throat region (also referred to herein as a throat section or a throat). The first section may be a plasma generating section and the second section may be a carbon particle generating section. At least a subset of the one or more gases (e.g., a feedstock) may be added to the thermal generator 110.

Reaction products may be cooled after manufacture. A quench (e.g., comprising a process gas) may be used to cool the reaction products. For example, a quench comprising a majority of hydrogen gas may be used. The quench may be added (e.g., injected) in the reactor 120. A heat exchanger 130 (e.g., connected to the reactor 120) may cool an effluent stream comprising the reaction products. In the heat exchanger, gaseous reaction products may be exposed to a large surface area and thus allowed to cool while solid carbonaceous material may be simultaneously transported through the process. The solid carbonaceous material may pass through a filter (e.g., a main filter) 140 (e.g., connected to the heat exchanger 130). The filter may allow, for example, more than 50% of the gaseous reaction products to pass through, capturing substantially all of the solid carbonaceous material on the filter. For example, at least about 98% by mass of the solid carbonaceous material may be captured on the filter.

The gaseous reaction products may be provided or coupled to one or more uses, recycled back into the reactor (e.g., as a process gas), or any combination thereof. The solid carbonaceous material with residual gaseous reaction products may pass through a degassing unit or degasser (e.g., degas chamber or degas apparatus) 150 (e.g., connected to the filter 140) where the amount of combustible gas is reduced (e.g., to less than about 10% by volume).

The solid carbonaceous material may then pass through back end equipment 160. The back end equipment 160 may include, for example, one or more of a pelletizer (e.g., connected to the degas apparatus 150), a binder mixing tank (e.g., connected to the pelletizer), a dryer (e.g., connected to the pelletizer) or a bagger as non-limiting example(s) of components or unit operations. For example, the solid carbonaceous material (e.g., carbon black) may be pelletized in the pelletizer and dried in the dryer (e.g., mixed with water with a binder and then formed into pellets, followed by removal of the majority of the water in a dryer). The solid carbonaceous material may also pass through classifier(s), hammer mill(s), or other size reduction equipment (e.g., so as to reduce the proportion of grit in the product). As non-limiting examples of other components or unit operations, one or more of a conveying process or conveying unit, purge filter unit (e.g., which may filter solid carbonaceous material out of steam vented from the dryer), dust filter unit (e.g., which may collect dust from other equipment), other process filter, other hydrogen/tail gas removal unit, cyclone, other bulk separation (e.g., solid/gas separation) unit, off quality product blending unit, etc. (e.g., other components or unit operations described elsewhere herein) may be added or substituted in the system 100.

Components or unit operations may be added or removed as appropriate. For example, system 100 may include at least one or more heat exchangers 130, one or more filters 140, and back end equipment 160 comprising solids handling equipment. The solids handling equipment may include, for example, a cooled solid carbon collection screw conveyor, an air locking and purge system, a pneumatic conveying system, a mechanical conveying system (e.g., a conveyor belt auger or elevator), a classifying mill, and/or a product storage vessel. The carbon particles may be collected at a single location (e.g., all of the carbon particles may be collected at one location) or at multiple locations.

The feedstock (e.g., a hydrocarbon feedstock comprising one or more hydrocarbons, hydrocarbon derivatives, or combination thereof) may begin to crack and decompose before being fully converted into solid carbonaceous material. Heat may further be provided through latent radiant heat from the wall of the reactor 120. This may occur through heating of the walls (or portions thereof) via externally provided energy or through heating of the walls (or portions thereof) from the heated gas(es) in the reactor. For example, hydrogen and carbonaceous material (e.g., carbon particles) may be produced in a process comprising adding a hydrocarbon feedstock (e.g., natural gas or renewable natural gas) to a plasma generator 110 at or above atmospheric pressures. The hydrocarbon feedstock may be added through direct injection (e.g., direct injection of the feedstock) into the plasma generated by the plasma generator. The energy from the plasma generator may remove hydrogen from the hydrocarbon. The process may additionally include the use of one or more heat exchangers 130, filters 140, degas chambers 150, and/or solids handling equipment and other back end equipment 160 as described above.

### Reactor Fouling

Reactions that generate carbonaceous materials or hydrogen may be prone to fouling. Fouling material may be unwanted buildup of solids on containment walls (e.g., walls of a reactor 120). Fouling may generate run-away propagation and premature shutdown of equipment. Buildup of solids on the containment walls (e.g., reactor fouling) may be reduced through control of Time of Flight of reacting flows in chemical and power production devices using the systems and methods of the present disclosure. Time of Flight may be the time between initial introduction of fluid reactants in a chamber or container and the point at which the reactants and reaction products contact the containment wall. Increasing Time of Flight may reduce contact between reactants and reaction products and containment walls, which in turn may reduce buildup of solids and reactor fouling.

In a continuous reaction process, a reaction chamber geometry may comprise or be a straight cylinder. Alternatively, or in addition, a reaction chamber geometry may comprise or be a cylinder with a narrowing portion or throat section. In a reactor 120 with a throat section, the reactants may be mixed in the throat section prior to entering the main, larger diameter reaction chamber. The characteristics of the reactant flow fields entering into the reaction chamber may control, alter, or maximize the Time of Flight of the reactants. Thus, a reactor may include a plasma generating section and a carbon particle generating section. A throat section may be disposed between the plasma generating section and carbon particle generating section. The throat section may be upstream of the carbon particle generating section. The throat section may comprise a narrow diameter that rapidly expands into the carbon particle generating section. The narrowing of the diameter followed by rapid expansion (e.g., a reactor flow path having a smaller diameter in an upstream throat section and a larger diameter in a downstream carbon particle generating section) may generate a recirculation bubble of reactants and reaction products that buffers the main flow from the solid containment wall (e.g., the recirculation bubble may reduce contact between reactants or reaction products and the containment wall).

In some cases, bulk flow “swirling” may be detrimental to stable operation of reactors by reducing Time of Flight. By reducing Time of Flight, swirling may increase contact between the reactants and reaction products and the containment (e.g., reactor) wall. Swirling may include fluid flow in a turbulent flow regime in which fluid particles comprise a tangential component of velocity about an axis that, when combined with an axial component of velocity, generates a helical or spiral flow pattern. The swirling of the bulk flow may be defined by the bulk flow Swirl Number, which may be defined as a ratio of angular momentum to linear momentum. Angular momentum may act in a plane perpendicular to the linear motion of the fluid. High Swirl Number flows may have an effect of quickly mixing reactants along a plane perpendicular to the axis of the main flow to reduce Time of Flight. In a reaction chamber comprising a rapid expansion zone, high Swirl Number flows may shorten the axial recirculation bubble due to the higher angular acceleration of the fluid as compared to a reaction chamber without a rapid expansion zone. Shortening the axial recirculation bubble may aid in overcoming transverse pressure imbalance from conservation of axial momentum. Example analyses of swirling flows that one or more embodiments of the systems and methods of the present disclosure can be used to modulate can be found in, for example, Chuang, S.-H., Lin, H.-C., Tai, F.-M., and Sung, H.-M., “Hot flow analysis of swirling sudden-expansion dump combustor,” International Journal for Numerical Methods in Fluids, vol. 14, pp. 217-239, 1992. doi:10.1002/fld.1650140208.

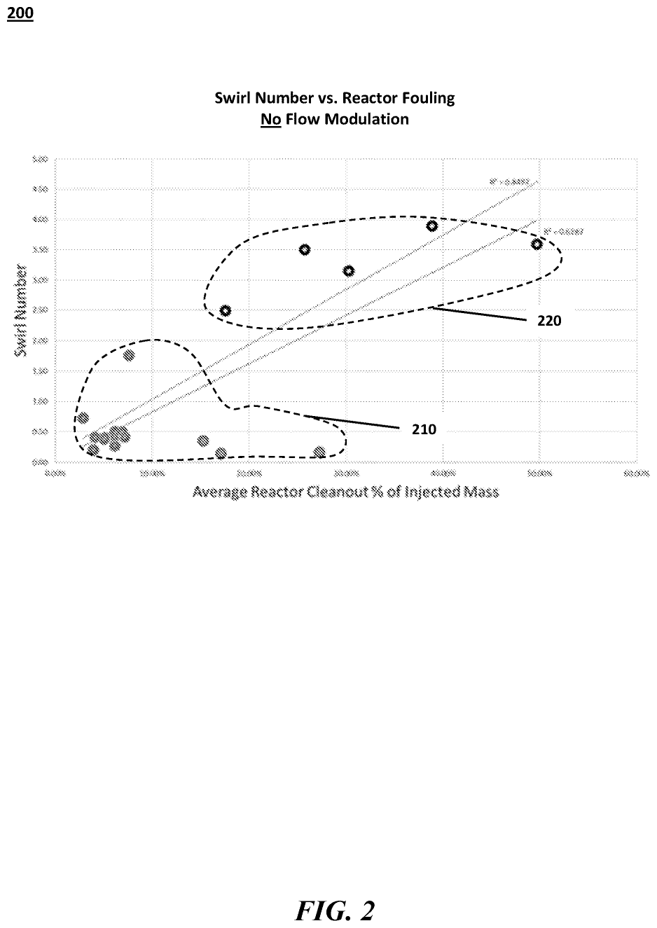

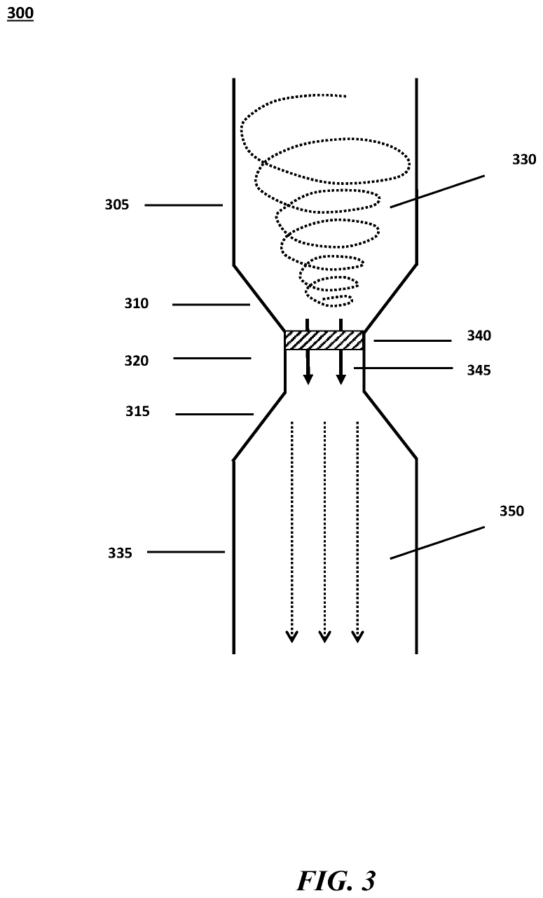

FIG. 2 an example graph of Swirl Number as a function of average reactor cleanout as mass percent of total injected feedstock (Reactor Fouling) for various injector configurations without the benefit of the systems and methods of the present disclosure. As generally shown in FIG. 2, a Swirl Number of less than about 1 may reduce the mass of large carbon particle buildup collected from a reaction chamber (e.g., fouling of the carbon particle generating section described with reference to FIG. 3 below). Axial injector/cylinder data group 210 reflects results of reactor runs with gas injection between electrodes at the top of the reactor, in an axial direction downstream, in a cylindrical reactor without a throat section. Side injector/throat data group 220 reflects results of reactor runs with gas injection in a lateral direction, in or near the throat, in a reactor with a throat section. A throat section is described below with reference to FIG. 3 and also in various co-owned patent publications, including at least U.S. Pat. No. 10,138,378 (Plasma Gas Throat Assembly and Method, incorporated by reference herein in its entirety. As suggested in FIG. 2, there is a need for systems and methods to achieve results the same as or better than axial injector/cylinder data group 210, i.e., approaching Swirl Number of zero and Reactor Fouling of zero, while employing reactors with a throat section as with side injector/throat data group 220.

### Flow Straightening

In chemical and power production devices in which a minimum Time of Flight can avoid unwanted fouling, the Swirl Number of the bulk reacting flow can be controlled to reduce fouling. In reactor systems prone to fouling, systems and methods may be used to increase Time of Flight to reduce fouling. For example, in plasma reactors angular momentum may be imparted to bulk fluid by rotating an electrical arc. The swirl number (Ssw) provided to the bulk fluid by a rotating electrical arc may be calculated as shown in Equation 1:

$${S}_{s w} = \frac{{r}_{a r c} {Il}_{r} {B}_{z}}{{R}_{r x} ( {ρ}_{j} {U}_{j}^{2} \frac{π}{4} {d}_{j}^{2} )} \approx \frac{A n gular Momentum}{Reactor Radius \cdot Axial momentum} \qquad ( 1 )$$

where r_{arc} is the radius to the center of the arc, I is the arc current, Iᵣ is the radial length of the arc, B_{z} is the magnetic field strength flow in the axial direction, ρⱼ is the density of injected feedstock, Uⱼ is the axial velocity of the injected feedstock, dⱼ is the diameter of the injector nozzle, and Rᵣₓ is the internal radius of the carbon particle generating section.

FIG. 3 shows a schematic representation of flows before and after an obstacle according to one or more embodiments of the present disclosure. A reactor 300 may include an upstream section 305 containing electrodes (not shown) between which a gas may flow, where an electric arc will excite the gas into a plasma state. The electric arc may be controlled through use of a magnetic field which moves the arc in a circular fashion rapidly around the electrode tips. The reactor may include a converging region 310 and a diverging region 315 defining a throat 320. A hydrocarbon feedstock is then injected into the plasma gas through an injector (not shown). The hydrocarbon injector(s) can be located anywhere on a plane at or near the throat 320, past the converging region 310 or further downstream of the throat 320 in the diverging region 315 of the reactor 300.

As depicted schematically in FIG. 3, a swirling flow 330 may occur in upstream section 305. The swirling flow 330 of bulk fluid may have an angular momentum (e.g., imparted by the rotating electrical arc, feedstock injection, turbulent condition, and/or the like). To modify, control, or influence the swirling flow 330 of the bulk fluid in the upstream section 305 before the bulk fluid reaches the downstream section 335 of the reactor 300, a static mechanical device comprising an obstacle 340 may be disposed between the upstream section 305 and the downstream section 335. The obstacle 340 may be configured to modulate the swirling flow 330 before the obstacle 340 to a modulated flow 350 after the obstacle 340. As shown, the modulation of the bulk flow via the obstacle 340 may occur as the bulk fluid flows through the obstacle 340 in a flow path direction 345 from the upstream section 305 toward the downstream section 335. The modulation of the bulk fluid via the obstacle 340 may result in increased Time of Flight, decreased angular momentum, increased linear momentum, and/or decreased Swirl Number for the modulated flow 350 relative to the swirling flow 330.

The Swirl Number may be controlled or altered by equipment upstream of the reaction chamber. Swirling flows may enhance mixing of reactants and flame retention in combustion devices. Swirling flows may be provided by upstream piping configurations, such as elbows and narrowing regions that may cause secondary flow field effects through conservation of fluid momentum. Mechanical devices also may be used to provide or impart angular momentum to the fluid. Mechanical devices may include rotating machinery, such as fan blades without stators to redirect the momentum. Alternatively, or in addition, swirl may be provided or imparted to the fluid flow by rapid rotation of an electric arc on a heating element. Fluid properties of the electric arc plasma core may be so dissimilar from that of the bulk fluid that the arc can be considered a “bluff body.” Rapid rotation of the arc may impart swirl from the drag force between the arc core and the bulk fluid, similar to a rotating mechanical device. The arc may rotate at a rate of greater than or equal to about 200 hertz (Hz), 300 Hz, 400 Hz, 500 Hz, 600 Hz, 800 Hz, 1000 Hz, 1200 Hz, 1400 Hz, 1600 Hz, 1800 Hz, 2000 Hz, 2200 Hz, 2400 Hz, 2600 Hz, 2800 Hz, 3000 Hz, 3200 Hz, 3400 Hz, or greater. The arc may rotate at a rate of less than or equal to about 3400 Hz, 3200 Hz, 3000 Hz, 2800 Hz, 2600 Hz, 2400 Hz, 2200 Hz, 2000 Hz, 1800 Hz, 1600 Hz, 1400 Hz, 1200 Hz, 1000 Hz, 800 Hz, 600 Hz, 500 Hz, 400 Hz, 300 Hz, 200 Hz, or less. The arc may rotate at a rate in a range from about 200 Hz to 300 Hz, 200 Hz to 400 Hz, 200 Hz to 500 Hz, 200 Hz to 600 Hz, 200 Hz to 800 Hz, 200 Hz to 1000 Hz, 200 Hz to 1200 Hz, 200 Hz to 1400 Hz, 200 Hz to 1600 Hz, 200 Hz to 1800 Hz, 200 Hz to 2000 Hz, 200 Hz to 2200 Hz, 200 Hz to 2400 Hz, 200 Hz to 2600 Hz, 200 Hz to 2800 Hz, 200 Hz to 3000 Hz, 200 Hz to 3200 Hz, 200 Hz to 3400 Hz, 300 Hz to 400 Hz, 300 Hz to 500 Hz, 300 Hz to 600 Hz, 300 Hz to 800 Hz, 300 Hz to 1000 Hz, 300 Hz to 1200 Hz, 300 Hz to 1400 Hz, 300 Hz to 1600 Hz, 300 Hz to 1800 Hz, 300 Hz to 2000 Hz, 300 Hz to 2200 Hz, 300 Hz to 2400 Hz, 300 Hz to 2600 Hz, 300 Hz to 2800 Hz, 300 Hz to 3000 Hz, 300 Hz to 3200 Hz, 300 Hz to 3400 Hz, 400 Hz to 500 Hz, 400 Hz to 600 Hz, 400 Hz to 800 Hz, 400 Hz to 1000 Hz, 400 Hz to 1200 Hz, 400 Hz to 1400 Hz, 400 Hz to 1600 Hz, 400 Hz to 1800 Hz, 400 Hz to 2000 Hz, 400 Hz to 2200 Hz, 400 Hz to 2400 Hz, 400 Hz to 2600 Hz, 400 Hz to 2800 Hz, 400 Hz to 3000 Hz, 400 Hz to 3200 Hz, 400 Hz to 3400 Hz, 500 Hz to 600 Hz, 500 Hz to 800 Hz, 500 Hz to 1000 Hz, 500 Hz to 1200 Hz, 500 Hz to 1400 Hz, 500 Hz to 1600 Hz, 500 Hz to 1800 Hz, 500 Hz to 2000 Hz, 500 Hz to 2200 Hz, 500 Hz to 2400 Hz, 500 Hz to 2600 Hz, 500 Hz to 2800 Hz, 500 Hz to 3000 Hz, 500 Hz to 3200 Hz, 500 Hz to 3400 Hz, 600 Hz to 800 Hz, 600 Hz to 1000 Hz, 600 Hz to 1200 Hz, 600 Hz to 1400 Hz, 600 Hz to 1600 Hz, 600 Hz to 1800 Hz, 600 Hz to 2000 Hz, 600 Hz to 2200 Hz, 600 Hz to 2400 Hz, 600 Hz to 2600 Hz, 600 Hz to 2800 Hz, 600 Hz to 3000 Hz, 600 Hz to 3200 Hz, 600 Hz to 3400 Hz, 800 Hz to 1000 Hz, 800 Hz to 1200 Hz, 800 Hz to 1400 Hz, 800 Hz to 1600 Hz, 800 Hz to 1800 Hz, 800 Hz to 2000 Hz, 800 Hz to 2200 Hz, 800 Hz to 2400 Hz, 800 Hz to 2600 Hz, 800 Hz to 2800 Hz, 800 Hz to 3000 Hz, 800 Hz to 3200 Hz, 800 Hz to 3400 Hz, 1000 Hz to 1200 Hz, 1000 Hz to 1400 Hz, 1000 Hz to 1600 Hz, 1000 Hz to 1800 Hz, 1000 Hz to 2000 Hz, 1000 Hz to 2200 Hz, 1000 Hz to 2400 Hz, 1000 Hz to 2600 Hz, 1000 Hz to 2800 Hz, 1000 Hz to 3000 Hz, 1000 Hz to 3200 Hz, 1000 Hz to 3400 Hz, 1200 Hz to 1400 Hz, 1200 Hz to 1600 Hz, 1200 Hz to 1800 Hz, 1200 Hz to 2000 Hz, 1200 Hz to 2200 Hz, 1200 Hz to 2400 Hz, 1200 Hz to 2600 Hz, 1200 Hz to 2800 Hz, 1200 Hz to 3000 Hz, 1200 Hz to 3200 Hz, 1200 Hz to 3400 Hz, 1400 Hz to 1600 Hz, 1400 Hz to 1800 Hz, 1400 Hz to 2000 Hz, 1400 Hz to 2200 Hz, 1400 Hz to 2400 Hz, 1400 Hz to 2600 Hz, 1400 Hz to 2800 Hz, 1400 Hz to 3000 Hz, 1400 Hz to 3200 Hz, 1400 Hz to 3400 Hz, 1600 Hz to 1800 Hz, 1600 Hz to 2000 Hz, 1600 Hz to 2200 Hz, 1600 Hz to 2400 Hz, 1600 Hz to 2600 Hz, 1600 Hz to 2800 Hz, 1600 Hz to 3000 Hz, 1600 Hz to 3200 Hz, 1600 Hz to 3400 Hz, 1800 Hz to 2000 Hz, 1800 Hz to 2200 Hz, 1800 Hz to 2400 Hz, 1800 Hz to 2600 Hz, 1800 Hz to 2800 Hz, 1800 Hz to 3000 Hz, 1800 Hz to 3200 Hz, 1800 Hz to 3400 Hz, 2000 Hz to 2200 Hz, 2000 Hz to 2400 Hz, 2000 Hz to 2600 Hz, 2000 Hz to 2800 Hz, 2000 Hz to 3000 Hz, 2000 Hz to 3200 Hz, 2000 Hz to 3400 Hz, 2200 Hz to 2400 Hz, 2200 Hz to 2600 Hz, 2200 Hz to 2800 Hz, 2200 Hz to 3000 Hz, 2200 Hz to 3200 Hz, 2200 Hz to 3400 Hz, 2400 Hz to 2600 Hz, 2400 Hz to 2800 Hz, 2400 Hz to 3000 Hz, 2400 Hz to 3200 Hz, 2400 Hz to 3400 Hz, 2600 Hz to 2800 Hz, 2600 Hz to 3000 Hz, 2600 Hz to 3200 Hz, 2600 Hz to 3400 Hz, 2800 Hz to 3000 Hz, 2800 Hz to 3200 Hz, 2800 Hz to 3400 Hz, 3000 Hz to 3200 Hz, 3000 Hz to 3400 Hz, or 3200 Hz to 3400 Hz.

Swirling flow may be redirected using a static mechanical device (e.g., a stator or a diffuser). Static mechanical devices may impart a shear force to bulk fluid flow (e.g., bulk fluid flowing from plasma generating section to carbon particle generating section) to dissipate excess momentum and permit the flow field to be driven by the pressure gradient. The bulk fluid may comprise thermal transfer gas, feedstock, or any combination thereof, or any fluid in a swirling and/or turbulent flow amenable to reduction of angular momentum. Static mechanical devices may redirect flow by reducing and/or dissipating angular momentum in the bulk fluid flow.

Static mechanical devices may comprise obstacle(s) disposed in the fluid flow path. An obstacle may comprise one or more flat plates, curved plates, gridded plates, perforated plates, or other complex geometries. A static mechanical device may break up or divide fluid flow from the plasma generating section to the carbon particle generating section into a number of smaller co-rotating vortices that impart or provide shear on one another upon exiting the device. The co-rotating vortices imparting or providing shear on one another may dissipate or reduce angular momentum of the vortices. A reactor with a static mechanical device reducing or dissipating angular momentum of the bulk fluid may increase Time of Flight and reduce reactor fouling as compared to a reactor without a static mechanical device. Contacting the bulk fluid with a static mechanical device may reduce the angular momentum of the bulk fluid by at least about 20%, 30%, 40%, 50%, 60%, 70%, 80%, 90%, or more as compared to the bulk fluid not contacted with the static mechanical device. In an example, contacting the bulk fluid with the static mechanical device may reduce the angular momentum of the bulk fluid by at least about 50% as compared to the bulk fluid not contacted with the static mechanical device. In another example, contacting the bulk fluid with the static mechanical device may reduce the angular momentum of the bulk fluid by at least about 90% as compared to the bulk fluid not contacted with the static mechanical device. Contacting the bulk fluid with the static mechanical device may reduce a ratio of angular momentum to linear momentum of the bulk fluid. Contacting the bulk fluid with the static mechanical device may provide a fluid with a ratio of angular momentum to linear momentum that is less than or equal to about 2, 1.5, 1.25, 1, or less. In an example, contacting the bulk fluid with the static mechanical device may provide a fluid with a ratio of angular momentum to linear momentum that is less than or equal to 1.5. In another example, contacting the bulk fluid with the static mechanical device may provide a fluid with a ratio of angular momentum to linear momentum that is less than or equal to 1.25. In another example, contacting the bulk fluid with the static mechanical device may provide a fluid with a ratio of angular momentum to linear momentum that is less than or equal to 1.

In an example, a reactor system may include a plasma generating section coupled to a carbon particle generating section via a narrowing or a throat. The carbon particle generating system may be downstream of the plasma generating section. The system may further include an injector configured to inject or that injects a feedstock into a plasma generated in the plasma generating section. The feedstock may be injected into the plasma generating section, throat, or carbon particle generating section. In an example, the feedstock is injected into the carbon particle generating section. The system may further include a static mechanical device comprising one or more obstacles. The static mechanical device may be disposed in the throat, upstream of the throat (e.g., between the plasma generating section and the throat), or downstream of the throat (e.g., between the throat and the carbon particle generating section). In an example, the static mechanical device is disposed at an entrance to or an exit from the throat section. The feedstock may be injected upstream of the static mechanical device, into the static mechanical device, or downstream of the static mechanical device. In an example, the static mechanical device is disposed upstream of the throat and the feedstock is injected upstream of the static mechanical device. In another example, the static mechanical device is disposed upstream of the throat and the feedstock is injected in the static mechanical device. In another example, the static mechanical device is disposed upstream of the throat and the feedstock is injected downstream of the static mechanical device. In another example, the static mechanical device is disposed in the throat and the feedstock is injected upstream of the static mechanical device. In another example, the static mechanical device is disposed in the throat and the feedstock is injected into the static mechanical device. In another example, the static mechanical device is disposed in the throat and the feedstock is injected downstream of the static mechanical device. In another example, the static mechanical device is disposed downstream of the throat and the feedstock is injected upstream of the static mechanical device. In another example, the static mechanical device is disposed downstream of the throat and the feedstock is injected into the static mechanical device. In another example, the static mechanical device is disposed downstream of the throat and the feedstock is injected downstream of the static mechanical device. Alternatively, the static mechanical device may be disposed in multiple sections of the reactor. For example, the static mechanical device may be disposed at least partially in the plasma generating section and the throat or at least partially in the throat and the carbon particle generating section.

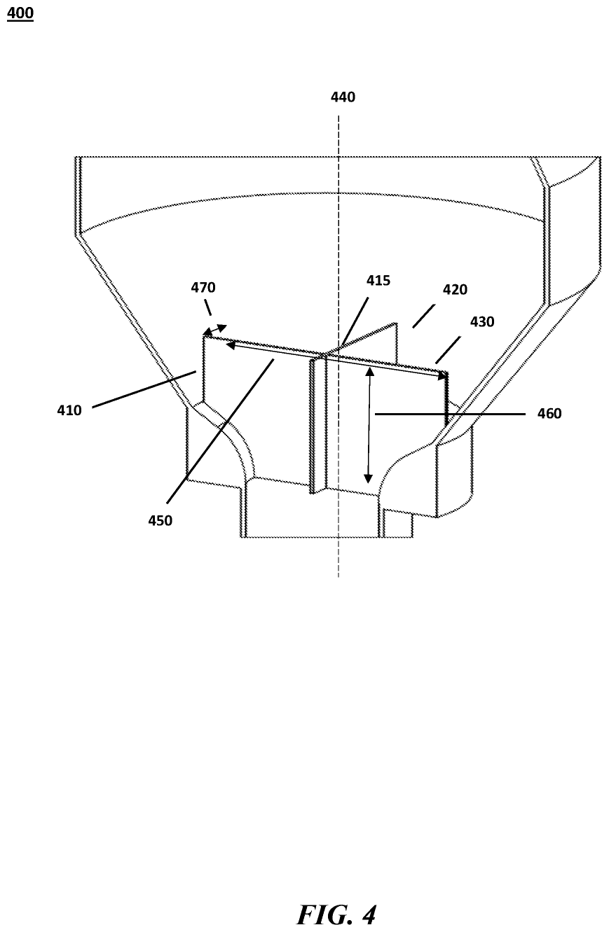

A static mechanical device may comprise one or more obstacles. FIGS. 4, 5, and 6 show various example obstacle configurations. An obstacle may be a plate (e.g., flat or curved plate). The plates of the static mechanical device may be coupled to or fixed to or in direct or indirect contact with walls of the reactor (e.g., walls of the plasma generating section, throat, or carbon particle generating section).

FIG. 4 shows a side-view example obstacle configuration 400 comprising intersecting plates, according to one or more embodiments of the present disclosure. As shown in FIG. 4, astatic mechanical device may comprise an obstacle 410 comprising one or more flat plates 420, 430. The obstacle 410 may be disposed in or upstream of a throat section of the reactor. The obstacle 410 may have a midpoint 415 that intersects with a center axis 440 of the reactor (e.g., plasma generating section, throat, or carbon particle generating section). As shown in the example of FIG. 4, the static mechanical device obstacle 410 may comprise two flat plates 440 and 450 disposed perpendicular to or substantially perpendicular to one another to form a cross-like configuration. The two plates 440 and 450 may intersect and contact at a midpoint 415 and the midpoint 415 may correspond to the axis 440 or center point of the reactor (e.g., particle generating section, throat, or carbon particle generating section). Each plate may have a first dimension 450, a second dimension 460, and a third dimension 470.

The static mechanical device may comprise a plurality of flat plates. The static mechanical device may comprise greater than or equal to about 1, 2, 3, 4, 5, 6, 8, 10, 12, or more flat plates. The plurality of plates may intersect at a midpoint. An angle between the plates may be less than or equal to about 90 degrees (°), 80°, 70°, 60°, 50°, 40°, 30°, 20°, or less. In an example, and as shown in FIG. 4, the static mechanical device may comprise two plates and an angle between the two plates may be less than or equal to about 90°. In another example, the static mechanical device may comprise four plates and an angle between the plates may be less than or equal to about 45°. The plurality of plates may have a same angle between all of the plates or different angles between different plates.

The first dimension 450 of the flat plate may span the fluid flow path of the reactor (e.g., may be perpendicular to an average fluid flow path or direction of fluid flow of the reactor). For example, the obstacle may be disposed in or near the throat and the first dimension 450 of the plate may span a diameter of the throat. Alternatively, the obstacle may be disposed in or near the throat and the first dimension 450 of the plate may span a half-diameter or radius of the throat. The first dimension 450 of the plate may be equal to or substantially equal to a diameter of the throat or may be equal to or substantially equal to a radius of the throat. Alternatively, the first dimension 450 of the plate may be equal to or substantially equal to a distance between interior walls of the reactor (e.g., plasma generating section, throat, carbon particle generating section, etc.). The second dimension 460 of the flat plate may be the dimension parallel to the fluid flow path. The plate may be disposed such that the fluid flow path flows along both sides of the plate parallel to the second dimension 460 dimension of the plate. The second dimension 460 of the plate may be greater than or equal to about 200 millimeter (mm), 400 mm, 600 mm, 800 mm, 1000 mm, 1200 mm, 1400 mm, 1600 mm, 1800 mm, 2000 mm, 2200 mm, 2400 mm, or more. The second dimension 460 of the plate may be less than or equal to about 2400 mm, 2200 mm, 2000 mm, 1800 mm, 1600 mm, 1400 mm, 1200 mm, 1000 mm, 800 mm, 600 mm, 400 mm, 200 mm, or less. The second dimension 460 of the plate may be in a range from about 200 mm to 400 mm, 200 mm to 600 mm, 200 mm to 800 mm, 200 mm to 1000 mm, 200 mm to 1200 mm, 200 mm to 1400 mm, 200 mm to 1600 mm, 200 mm to 1800 mm, 200 mm to 2000 mm, 200 mm to 2200 mm, 200 mm to 2400 mm, 400 mm to 600 mm, 400 mm to 800 mm, 400 mm to 1000 mm, 400 mm to 1200 mm, 400 mm to 1400 mm, 400 mm to 1600 mm, 400 mm to 1800 mm, 400 mm to 2000 mm, 400 mm to 2200 mm, 400 mm to 2400 mm, 600 mm to 800 mm, 600 mm to 1000 mm, 600 mm to 1200 mm, 600 mm to 1400 mm, 600 mm to 1600 mm, 600 mm to 1800 mm, 600 mm to 2000 mm, 600 mm to 2200 mm, 600 mm to 2400 mm, 800 mm to 1000 mm, 800 mm to 1200 mm, 800 mm to 1400 mm, 800 mm to 1600 mm, 800 mm to 1800 mm, 800 mm to 2000 mm, 800 mm to 2200 mm, 800 mm to 2400 mm, 1000 mm to 1200 mm, 1000 mm to 1400 mm, 1000 mm to 1600 mm, 1000 mm to 1800 mm, 1000 mm to 2000 mm, 1000 mm to 2200 mm, 1000 mm to 2400 mm, 1200 mm to 1400 mm, 1200 mm to 1600 mm, 1200 mm to 1800 mm, 1200 mm to 2000 mm, 1200 mm to 2200 mm, 1200 mm to 2400 mm, 1400 mm to 1600 mm, 1400 mm to 1800 mm, 1400 mm to 2000 mm, 1400 mm to 2200 mm, 1400 mm to 2400 mm, 1600 mm to 1800 mm, 1600 mm to 2000 mm, 1600 mm to 2200 mm, 1600 mm to 2400 mm, 1800 mm to 2000 mm, 1800 mm to 2200 mm, 1800 mm to 2400 mm, 2000 mm to 2200 mm, 2000 mm to 2400 mm, or 2200 mm to 2400 mm. The plate may comprise a third dimension 470 (e.g., plate thickness) perpendicular to a flow path. The plate may have a third dimension 470 of greater than or equal to about 1 mm, 5 mm, 10 mm, 20 mm, 40 mm, 60 mm, 80 mm, 100 mm, or more. The plate may have a third dimension 470 of less than or equal to about 100 mm, 80 mm, 60 mm, 40 mm, 20 mm, 10 mm, 5 mm, 1 mm, or less. The plate may have a third dimension 470 in a range from about 1 mm to 5 mm, 1 mm to 10 mm, 1 mm to 20 mm, 1 mm to 40 mm, 1 mm to 60 mm, 1 mm to 80 mm, 1 mm to 100 mm, 5 mm to 10 mm, 5 mm to 20 mm, 5 mm to 40 mm, 5 mm to 60 mm, 5 mm to 80 mm, 5 mm to 100 mm, 10 mm to 20 mm, 10 mm to 40 mm, 10 mm to 60 mm, 10 mm to 80 mm, 10 mm to 100 mm, 20 mm to 40 mm, 20 mm to 60 mm, 20 mm to 80 mm, 20 mm to 100 mm, 40 mm to 60 mm, 40 mm to 80 mm, 40 mm to 100 mm, 60 mm to 80 mm, 60 mm to 100 mm, or 80 mm to 100 mm.

The static mechanical device may comprise an obstacle comprising a grid or array of interlocking plates. The grid or array of plates may comprise a subset of plates disposed in a first direction and another subset of plates disposed in a second direction. The first direction may be perpendicular to or substantially perpendicular to the second direction. The grid or array of plates may be disposed perpendicular to an average direction of fluid flow.

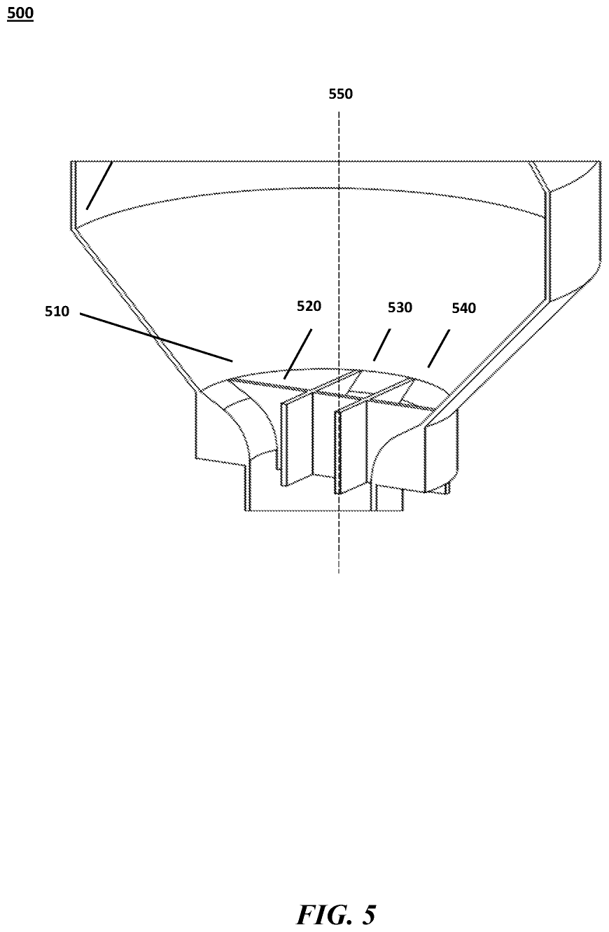

FIG. 5 shows a side-view example obstacle configuration 500 comprising a grid 510 of interlocking plates 520, 530, 540, according to one or more embodiments of the present disclosure. As shown in FIG. 5, the grid 510 may be disposed perpendicular to an axis 550 of the reactor (e.g., plasma generating section, throat, or carbon particle generating section) or the average direction of fluid flow. A grid or array of plates 510 may comprise greater than or equal to about 2, 3, 4, 5, 6, 8, 10, 12, or more plates.

The static mechanical device may comprise a plurality of obstacles coupled to or fixed to or in direct or indirect contact with a wall of the reactor (e.g., plasma generating section, throat, carbon particle generating section) and extending radially toward the center of the reactor. An obstacle of the plurality of obstacles may be a plate. The obstacles may or may not contact one another. The obstacles may be oriented randomly with respect to one another or may be radially positioned with respect to one another.

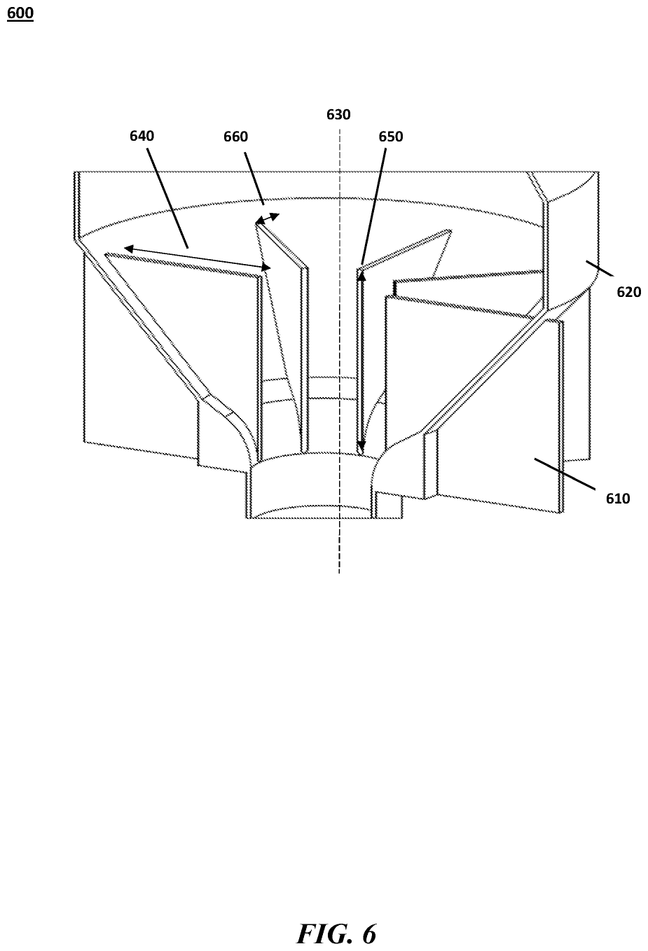

FIG. 6 shows a side-view example obstacle configuration 600 comprising a series of plates, for example plate 610, according to one or more embodiments of the present disclosure. As shown, one side of a plate 610 may be coupled to a wall 620 of the reactor and another side of the plate 610 may extend radially into the fluid flow path, e.g., an average bulk fluid flow path aligned or substantially aligned in a direction parallel with a central axis 630. A plate may have a first dimension 640 perpendicular to an average direction of fluid flow 630, a second dimension 650 parallel to an average direction of fluid flow 630, and a third dimension 660 (e.g., plate thickness) perpendicular to an average direction of fluid flow 550.

A plate fixed to the wall may have a first dimension 640 that may be greater than or equal to about 200 mm, 400 mm, 600 mm, 800 mm, 1000 mm, 1200 mm, 1400 mm, 1600 mm, 1800 mm, 2000 mm, 2200 mm, 2400 mm, or more. The first dimension 640 may be less than or equal to about 2400 mm, 2200 mm, 2000 mm, 1800 mm, 1600 mm, 1400 mm, 1200 mm, 1000 mm, 800 mm, 600 mm, 400 mm, 200 mm, or less. The first dimension 640 may be in a range from about 200 mm to 400 mm, 200 mm to 600 mm, 200 mm to 800 mm, 200 mm to 1000 mm, 200 mm to 1200 mm, 200 mm to 1400 mm, 200 mm to 1600 mm, 200 mm to 1800 mm, 200 mm to 2000 mm, 200 mm to 2200 mm, 200 mm to 2400 mm, 400 mm to 600 mm, 400 mm to 800 mm, 400 mm to 1000 mm, 400 mm to 1200 mm, 400 mm to 1400 mm, 400 mm to 1600 mm, 400 mm to 1800 mm, 400 mm to 2000 mm, 400 mm to 2200 mm, 400 mm to 2400 mm, 600 mm to 800 mm, 600 mm to 1000 mm, 600 mm to 1200 mm, 600 mm to 1400 mm, 600 mm to 1600 mm, 600 mm to 1800 mm, 600 mm to 2000 mm, 600 mm to 2200 mm, 600 mm to 2400 mm, 800 mm to 1000 mm, 800 mm to 1200 mm, 800 mm to 1400 mm, 800 mm to 1600 mm, 800 mm to 1800 mm, 800 mm to 2000 mm, 800 mm to 2200 mm, 800 mm to 2400 mm, 1000 mm to 1200 mm, 1000 mm to 1400 mm, 1000 mm to 1600 mm, 1000 mm to 1800 mm, 1000 mm to 2000 mm, 1000 mm to 2200 mm, 1000 mm to 2400 mm, 1200 mm to 1400 mm, 1200 mm to 1600 mm, 1200 mm to 1800 mm, 1200 mm to 2000 mm, 1200 mm to 2200 mm, 1200 mm to 2400 mm, 1400 mm to 1600 mm, 1400 mm to 1800 mm, 1400 mm to 2000 mm, 1400 mm to 2200 mm, 1400 mm to 2400 mm, 1600 mm to 1800 mm, 1600 mm to 2000 mm, 1600 mm to 2200 mm, 1600 mm to 2400 mm, 1800 mm to 2000 mm, 1800 mm to 2200 mm, 1800 mm to 2400 mm, 2000 mm to 2200 mm, 2000 mm to 2400 mm, or 2200 mm to 2400 mm.

The plate fixed to the wall may have a second dimension 650 that may be greater than or equal to about 200 mm, 300 mm, 400 mm, 600 mm, 800 mm, 1200 mm, 1600 mm, 2000 mm, 2400 mm, 2800 mm, 3200 mm, 3600 mm, or more. The plate may have a second dimension 650 of less than or equal to about 3600 mm, 3200 mm, 2800 mm, 2400 mm, 2000 mm, 1600 mm, 1200 mm, 800 mm, 600 mm, 400 mm, 300 mm, 200 mm, or less. The plate may have a second dimension 650 that may be in a range from about 200 mm to 300 mm, 200 mm to 400 mm, 200 mm to 600 mm, 200 mm to 800 mm, 200 mm to 1200 mm, 200 mm to 1600 mm, 200 mm to 2000 mm, 200 mm to 2400 mm, 200 mm to 2800 mm, 200 mm to 3200 mm, 200 mm to 3600 mm, 300 mm to 400 mm, 300 mm to 600 mm, 300 mm to 800 mm, 300 mm to 1200 mm, 300 mm to 1600 mm, 300 mm to 2000 mm, 300 mm to 2400 mm, 300 mm to 2800 mm, 300 mm to 3200 mm, 300 mm to 3600 mm, 400 mm to 600 mm, 400 mm to 800 mm, 400 mm to 1200 mm, 400 mm to 1600 mm, 400 mm to 2000 mm, 400 mm to 2400 mm, 400 mm to 2800 mm, 400 mm to 3200 mm, 400 mm to 3600 mm, 600 mm to 800 mm, 600 mm to 1200 mm, 600 mm to 1600 mm, 600 mm to 2000 mm, 600 mm to 2400 mm, 600 mm to 2800 mm, 600 mm to 3200 mm, 600 mm to 3600 mm, 800 mm to 1200 mm, 800 mm to 1600 mm, 800 mm to 2000 mm, 800 mm to 2400 mm, 800 mm to 2800 mm, 800 mm to 3200 mm, 800 mm to 3600 mm, 1200 mm to 1600 mm, 1200 mm to 2000 mm, 1200 mm to 2400 mm, 1200 mm to 2800 mm, 1200 mm to 3200 mm, 1200 mm to 3600 mm, 1600 mm to 2000 mm, 1600 mm to 2400 mm, 1600 mm to 2800 mm, 1600 mm to 3200 mm, 1600 mm to 3600 mm, 2000 mm to 2400 mm, 2000 mm to 2800 mm, 2000 mm to 3200 mm, 2000 mm to 3600 mm, 2400 mm to 2800 mm, 2400 mm to 3200 mm, 2400 mm to 3600 mm, 2800 mm to 3200 mm, 2800 mm to 3600 mm, or 3200 mm to 3600 mm.

The plate fixed to the wall may have a third dimension 660 of greater than or equal to about 1 mm, 5 mm, 10 mm, 20 mm, 40 mm, 60 mm, 80 mm, 100 mm, or more. The plate may have a third dimension 660 of less than or equal to about 100 mm, 80 mm, 60 mm, 40 mm, 20 mm, 10 mm, 5 mm, 1 mm, or less. The plate may have a third dimension 660 in a range from about 1 mm to 5 mm, 1 mm to 10 mm, 1 mm to 20 mm, 1 mm to 40 mm, 1 mm to 60 mm, 1 mm to 80 mm, 1 mm to 100 mm, 5 mm to 10 mm, 5 mm to 20 mm, 5 mm to 40 mm, 5 mm to 60 mm, 5 mm to 80 mm, 5 mm to 100 mm, 10 mm to 20 mm, 10 mm to 40 mm, 10 mm to 60 mm, 10 mm to 80 mm, 10 mm to 100 mm, 20 mm to 40 mm, 20 mm to 60 mm, 20 mm to 80 mm, 20 mm to 100 mm, 40 mm to 60 mm, 40 mm to 80 mm, 40 mm to 100 mm, 60 mm to 80 mm, 60 mm to 100 mm, or 80 mm to 100 mm.

An obstacle of the plurality of obstacles may comprise a first surface area defined and bounded by the first dimension 640 and the second dimension 650. The first surface area may be disposed such that the first surface area is normal to, perpendicular to, or substantially perpendicular to an average direction of fluid flow (e.g., direction of the vector addition of linear/axial velocity and angular velocity of the fluid flow). The orientation of the obstacle(s) of the static mechanical device may impart a shear force on the bulk flow such that angular momentum is reduced or dissipated as the bulk fluid flows through the static mechanical device.

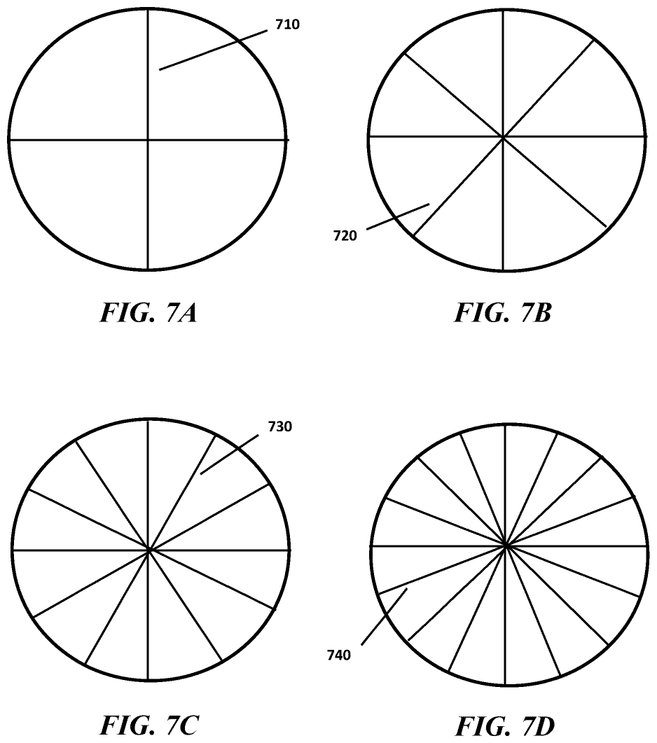

FIGS. 7A-7D show example top-view obstacle configurations, each according to one or more embodiments of the present disclosure, as described elsewhere herein. FIG. 7A shows an example obstacle configuration comprising two interlocking plates 710. FIG. 7B shows an example obstacle configuration comprising four interlocking plates 720. FIG. 7C shows an example obstacle configuration comprising six interlocking plates 730. FIG. 7D shows an example obstacle configuration comprising eight interlocking plates 740.

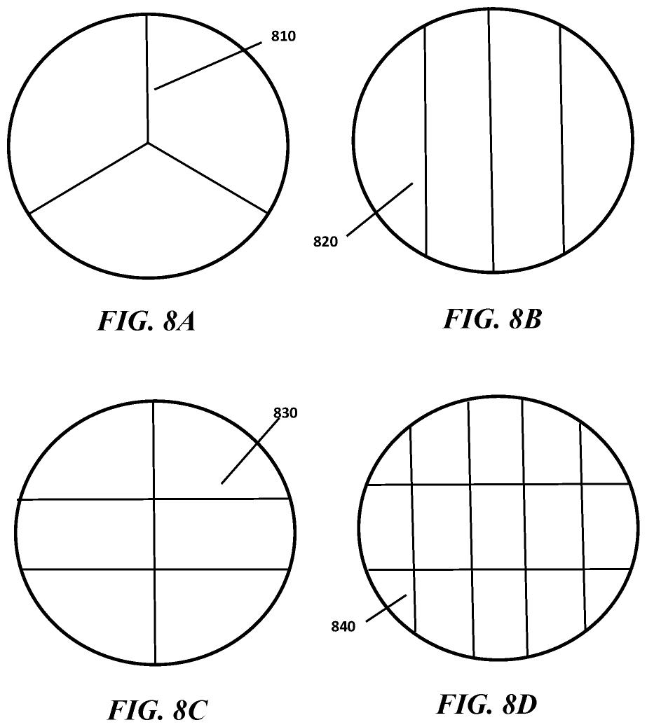

FIGS. 8A-8D show example top-view obstacle configurations, each according to one or more embodiments of the present disclosure, as described elsewhere herein. FIG. 8A shows an example obstacle configuration comprising three radially intersecting plates 810. FIG. 8B shows an example obstacle configuration comprising three non-intersecting plates 820. FIG. 8C shows an example obstacle configuration comprising a grid of three interlocking plates 830. FIG. 8D shows an example obstacle configuration comprising a grid of six interlocking plates 840.

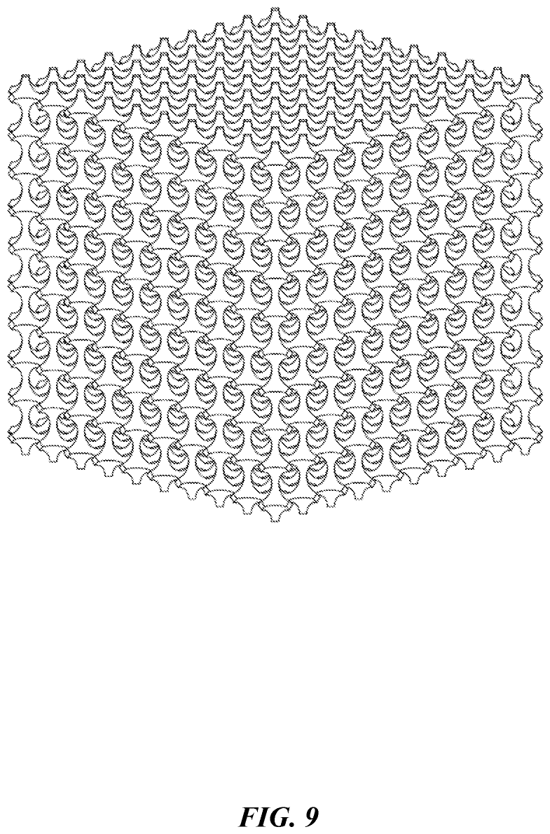

A static mechanical device may further comprise one or more obstacles comprising a tight latticework of solid material. FIG. 9 shows an example latticework structure according to one or more embodiments of the present disclosure. The latticework may comprise a three-dimensional structure with a series of patterned pores. The series of patterned pores may be a random series of pores or an organized pattern of pores. The latticework of solid material may provide drag on the flow and reduce bulk fluid flow momentum and velocity to momentum and velocity driven by the axial pressure gradient. In an example, the latticework of solid material may comprise a structure similar to an atomic metallic “lattice.” The latticework of solid material may comprise a plurality of pores that permit transport of the fluid therethrough. In an example, the latticework comprises a molecular sieve. In an example, the latticework comprises a sponge diffuser. Pores of the plurality of pores may have an average diameter of greater than or equal to about 0.5 mm, 1 mm, 2 mm, 3 mm, 4 mm, 5 mm, 10 mm, 20 mm, 30 mm, 40 mm, 50 mm, 60 mm, or more. Pores of the plurality of pores may have an average diameter of less than or equal to about 60 mm, 50 mm, 40 mm, 30 mm, 20 mm, 10 mm, 5 mm, 4 mm, 3 mm, 2 mm, 1 mm, 0.5 mm, or less. Pores of the plurality of pores may have an average diameter in a range from about 0.5 mm to 1 mm, 0.5 mm to 2 mm, 0.5 mm to 3 mm, 0.5 mm to 4 mm, 0.5 mm to 5 mm, 0.5 mm to 10 mm, 0.5 mm to 20 mm, 0.5 mm to 30 mm, 0.5 mm to 40 mm, 0.5 mm to 50 mm, 0.5 mm to 60 mm, 1 mm to 2 mm, 1 mm to 3 mm, 1 mm to 4 mm, 1 mm to 5 mm, 1 mm to 10 mm, 1 mm to 20 mm, 1 mm to 30 mm, 1 mm to 40 mm, 1 mm to 50 mm, 1 mm to 60 mm, 2 mm to 3 mm, 2 mm to 4 mm, 2 mm to 5 mm, 2 mm to 10 mm, 2 mm to 20 mm, 2 mm to 30 mm, 2 mm to 40 mm, 2 mm to 50 mm, 2 mm to 60 mm, 3 mm to 4 mm, 3 mm to 5 mm, 3 mm to 10 mm, 3 mm to 20 mm, 3 mm to 30 mm, 3 mm to 40 mm, 3 mm to 50 mm, 3 mm to 60 mm, 4 mm to 5 mm, 4 mm to 10 mm, 4 mm to 20 mm, 4 mm to 30 mm, 4 mm to 40 mm, 4 mm to 50 mm, 4 mm to 60 mm, 5 mm to 10 mm, 5 mm to 20 mm, 5 mm to 30 mm, 5 mm to 40 mm, 5 mm to 50 mm, 5 mm to 60 mm, 10 mm to 20 mm, 10 mm to 30 mm, 10 mm to 40 mm, 10 mm to 50 mm, 10 mm to 60 mm, 20 mm to 30 mm, 20 mm to 40 mm, 20 mm to 50 mm, 20 mm to 60 mm, 30 mm to 40 mm, 30 mm to 50 mm, 30 mm to 60 mm, 40 mm to 50 mm, 40 mm to 60 mm, or 50 mm to 60 mm. In an example, the pore size (e.g., pore diameter) may be greater than or equal to about 5 mm. In an example, the porous structure may be visible to a human eye. The pores of the latticework of solid material may be constant or may vary in size across the latticework of solid material. The size of the pores may vary by less than or equal to about 60%, 50%, 40%, 30%, 20%, 10%, or less. The latticework may be a randomly oriented lattice (e.g., similar to a natural sponge) or an ordered lattice. The latticework may be formed of solid carbon, carbon composite, ceramic, refractory metals, carbide variations of refractory metals, or any combination thereof.

Alternatively, or in addition, Swirl Number of a bulk fluid flow may be reduced through introduction of a secondary fluid to the bulk fluid flow. The secondary fluid may generate or impart a shear force in the bulk flow which may reduce or dissipate the total angular momentum of the combined fluids and reduce swirl.

The secondary fluid may have an angular momentum with a direction that opposes a direction of the angular momentum of the bulk fluid. An angle between the angular momentum of the secondary fluid and the bulk fluid may be greater than or equal to about 20 degrees (°), 30°, 40°, 50°, 60°, 70°, 80°, 90°, or more. An angle between the angular momentum of the secondary fluid and the bulk fluid may be less than or equal to about 90°, 80°, 70°, 60°, 50°, 40°, 30°, 20°, or less. An angle between the angular momentum of the secondary fluid and the bulk fluid may be in a range from about 20° to 30°, 20° to 40°, 20° to 50°, 20° to 60°, 20° to 70°, 20° to 80°, 20° to 90°, 30° to 40°, 30° to 50°, 30° to 60°, 30° to 70°, 30° to 80°, 30° to 90°, 40° to 50°, 40° to 60°, 40° to 70°, 40° to 80°, 40° to 90°, 50° to 60°, 50° to 70°, 50° to 80°, 50° to 90°, 60° to 70°, 60° to 80°, 60° to 90°, 70° to 80°, 70° to 900, or 80° to 90°.

The angular momentum of the secondary fluid may have a magnitude similar to or different from the angular momentum of the bulk fluid. The magnitude of the angular momentum of the bulk fluid may be greater than, less than, or equal to the magnitude of the angular momentum of the secondary fluid. In an example, the magnitude of the angular momentum of the bulk fluid is greater than the magnitude of the angular momentum of the secondary fluid. A ratio of the magnitude of angular momentum of the bulk fluid to the magnitude of the angular momentum of the secondary fluid may be greater than or equal to about 1, 1.25, 1.5, 2, 3, 4, 5, or more. In an example, a ratio of the magnitude of angular momentum of the bulk fluid to the magnitude of the angular momentum of the secondary fluid may be greater than or equal to about 1. In an example, a ratio of the magnitude of angular momentum of the bulk fluid to the magnitude of the angular momentum of the secondary fluid may be in a range from about 1 to 2, 1 to 3, 1 to 4, 1 to 5, 2 to 3, 2 to 4, 2 to 5, 3 to 4, 3 to 5, or 4 to 5. In an example, a ratio of the magnitude of angular momentum of the bulk fluid to the magnitude of the angular momentum of the secondary fluid may be in a range from about 1 to 5. In another example, a ratio of the magnitude of angular momentum of the bulk fluid to the magnitude of the angular momentum of the secondary fluid may be in a range from about 1 to 3. In another example, a ratio of the magnitude of angular momentum of the bulk fluid to the magnitude of the angular momentum of the secondary fluid may be in a range from about 1 to 2.

The secondary fluid may be the same fluid as the bulk fluid or a different fluid. The secondary fluid may comprise hydrogen, a hydrocarbon (e.g., methane, ethane, propane, etc.) or hydrocarbon derivative, or any combination thereof. Alternatively, or in addition, the secondary fluid may be an inert gas such as (for example) argon, nitrogen, carbon monoxide, carbon dioxide, or any combination thereof. In an example, the secondary fluid comprises reactant or feedstock. Contacting the bulk fluid with the secondary fluid may reduce the angular momentum of the bulk fluid by at least about 20%, 30%, 40%, 50%, 60%, 70%, 80%, 90%, or more as compared to the bulk fluid not contacted with the secondary fluid. The angular momentum of the bulk fluid may be reduced prior to the bulk fluid entering the carbon particle generating section of the reactor. In an example, contacting the bulk fluid with the secondary fluid may reduce the angular momentum of the bulk fluid by at least about 50%. In another example, contacting the bulk fluid with the secondary fluid may reduce the angular momentum of the bulk fluid by at least about 75%. In another example, contacting the bulk fluid with the secondary fluid may reduce the angular momentum of the bulk fluid by at least about 90%. Contacting the bulk fluid with the secondary fluid may provide a fluid with a ratio of angular momentum to linear momentum that is less than or equal to about 2, 1.5, 1.25, 1, or less. In an example, contacting the bulk fluid with the secondary fluid may provide a fluid with a ratio of angular momentum to linear momentum that is less than or equal to about 1.5. In another example, contacting the bulk fluid with the secondary fluid may provide a fluid with a ratio of angular momentum to linear momentum that is less than or equal to about 1.25. In another example, contacting the bulk fluid with the secondary fluid may provide a fluid with a ratio of angular momentum to linear momentum that is less than or equal to about 1.

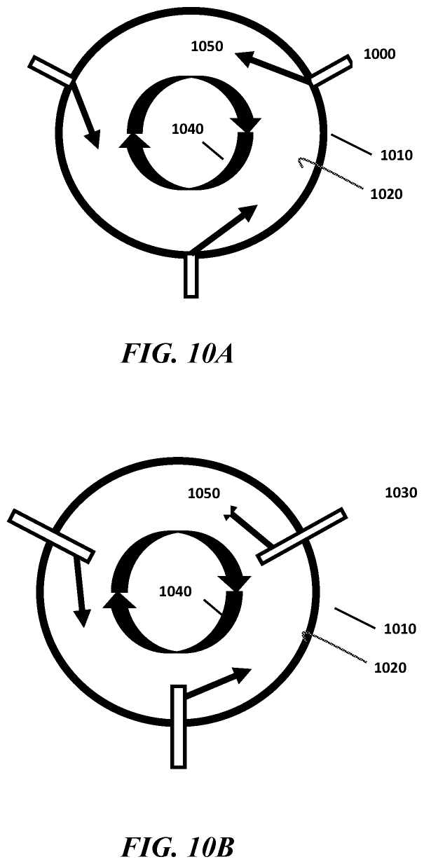

The secondary fluid may be provided to the reactor or injected using an injector (e.g., a nozzle or a set of nozzles). A set of injectors (e.g., nozzles) may be disposed in an upstream section of the reactor (e.g., in the plasma generating section, near the plasma generating electrodes, etc.). The set of injectors may be disposed outside of the bulk fluid flow or may protrude into the flow of the bulk fluid. FIGS. 10A and 10B show top-view example injector configurations, each according to one or more embodiments of the present disclosure. FIG. 10A shows an example injector configuration comprising injectors (e.g., nozzles) 1000 disposed at an outer circumference 1010 (e.g., wall) of a reactor that are configured to inject a secondary fluid along the circumference 1010 of the reactor through a reactor inner or interior wall 1020 (e.g., are flush mounted in the reactor wall). FIG. 10B shows an example injector configuration comprising injectors 1030 disposed within a reactor chamber (e.g., that extend into the reactor chamber through the reactor wall). The injectors (e.g., nozzles) may be disposed perpendicular to an outer circumference (e.g., wall) 1010 of the reactor and may extend radially into the reactor through internal wall 1020.

With reference to both FIGS. 10A and 10B, during use, the reactor may include a bulk fluid that rotates 1040 as it progresses down the length of the reactor (not shown). The bulk fluid may rotate 1040 clockwise or counterclockwise. The reactor may include an internal wall 1020 with one or more secondary fluid injectors 1000 (FIG. 10A) or 1030 (FIG. 10B) that are disposed through the wall 1020. The injectors 1000 may be flush mounted (e.g., as shown in FIG. 10A), or the injectors 1030 may protrude into the bulk fluid flow (e.g., as shown in FIG. 10B). The secondary fluid injectors 1000 or 1030 may generate a secondary fluid jet 1050 directed in opposition to the bulk fluid rotation 1040. An injector (e.g., nozzle) 1000 or 1030 may inject the secondary fluid 1050 into the rotating bulk fluid 1040 at an angle of greater than or equal to about 20 degrees (°), 30°, 40°, 50°, 60°, 70°, 80°, 90°, or more from the reactor internal wall 1020. An injector 1000 or 1030 may inject the secondary fluid 1050 into the rotating bulk fluid 1040 at an angle of less than or equal to about 90°, 80°, 70°, 60°, 50°, 40°, 30°, 20°, or less from the reactor wall 702. An injector 1000 or 1030 may inject the secondary fluid 1050 into the rotating bulk fluid 1040 at an angle in a range from about 20° to 30°, 20° to 40°, 20° to 50, 20° to 60°, 20° to 70°, 20° to 80°, 20° to 90°, 30° to 40°, 30° to 50°, 30° to 60°, 30° to 70°, 30° to 80°, 30° to 90°, 40° to 50°, 40° to 60°, 40° to 70°, 40° to 80°, 40° to 90°, 50° to 60°, 50° to 70°, 50° to 80°, 50° to 90°, 60° to 70°, 60° to 80°, 60° to 90°, 70° to 80°, 70° to 90°, or 80° to 90° from the reactor wall 1020. The secondary fluid 1040 may comprise reactant or feedstock, and a set of injectors (e.g., nozzles) 1000 or 1030 may inject the secondary fluid into the rotating main bulk flow 1050. The set of injectors 1000 or 1030 may comprise at least 2, 3, 4, 5, 6, 8, 10, or more injectors (e.g., nozzles). In an example, the set of injectors comprises at least three nozzles spaced equidistantly around the circumference of the reactor 1010. The set of injectors 1000 or 1030 may be positioned such that the angular momentum of the secondary fluid 1040 opposes the angular momentum of the rotating bulk fluid 1050 to minimize heat loss while providing balanced flow control. In another example, the set of injectors 1000 or 1030 comprises at least six nozzles. In another example, the set of injectors comprises at least 6 nozzles and the secondary fluid is additional feedstock. The nozzles may be a round jet, flat fan, cone shaped, or the like, or any alternative or combination thereof. The secondary fluid may contact the bulk fluid in the plasma generating section, throat, or carbon generating section of the reactor. In an example, the secondary fluid may contact the bulk fluid in the plasma generating section. In another example, the secondary fluid may contact the bulk fluid in the throat section. In another example, the secondary fluid may contact the bulk fluid in the carbon particle generating section. The bulk fluid may be contacted with the secondary fluid prior to formation of the carbon particles. Alternately, the bulk fluid may be contacted with the secondary fluid simultaneously with the formation of the carbon particles.

Methods for reducing angular momentum of bulk fluid flow, including providing a rotating electric arc, static mechanical device, or injection of secondary fluids, may reduce fouling. Reducing the angular momentum of the bulk fluid may occur prior to the bulk fluid entering the carbon particle generating section and before carbon particle formation. The fouling of the reactor (e.g., unwanted deposition of fouling material from a product stream on an internal surface of the reactor as a result of processing) may be reduced by greater than or equal to 5%, 10%, 15%, 20%, 30%, 40%, 50%, or more as compared to another reactor not using a rotating electric arc, static mechanical device, or injection of secondary fluids. The systems and methods described herein may reduce an amount of hydrocarbon feedstock that fouls the reactor (e.g., carbon particle generating section of the reactor). Reducing angular momentum of the bulk fluid flow may reduce an amount of hydrocarbon feedstock converted to fouling material to less than or equal to about 40%, 30%, 25%, 15%, 10%, 5%, or less of the hydrocarbon feedstock injected into the reactor (e.g., carbon particle generating section). In an example, reducing angular momentum of the bulk fluid flow reduces an amount of hydrocarbon feedstock converted to fouling material to less than or equal to about 25% of the hydrocarbon feedstock injected into the reactor (e.g., carbon particle generating section). In another example, reducing angular momentum of the bulk fluid flow reduces an amount of hydrocarbon feedstock converted to fouling material to less than or equal to about 15% of the hydrocarbon feedstock injected into the reactor (e.g., carbon particle generating section). In another example, reducing angular momentum of the bulk fluid flow reduces an amount of hydrocarbon feedstock converted to fouling material to less than or equal to about 10% of the hydrocarbon feedstock injected into the reactor (e.g., carbon particle generating section). In another example, reducing angular momentum of the bulk fluid flow reduces an amount of hydrocarbon feedstock converted to fouling material to less than or equal to about 5% of the hydrocarbon feedstock injected into the reactor (e.g., carbon particle generating section).

### Systems and Methods

The present disclosure provides systems and methods for effecting chemical changes. Effecting such chemical changes may include, for example, making or generating carbonaceous material, hydrogen, or a combination thereof using the systems and methods described herein. A carbonaceous material may be solid. A carbonaceous material may comprise or be, for example, carbon particles, a carbon-containing compound, or a combination thereof. A carbonaceous material may include, for example, carbon black. The systems (e.g., apparatuses) and methods of the present disclosure, and processes implemented with the aid of the systems and methods herein, may allow continuous production of, for example, carbonaceous material, hydrogen, or a combination thereof. The processes may include converting a feedstock (e.g., one or more hydrocarbons, hydrocarbon derivatives, or combination thereof). The systems and methods described herein may include heating one or more hydrocarbons rapidly to form, for example, carbonaceous material, hydrogen, or combination thereof. For example, one or more hydrocarbons may be heated rapidly to form carbon particles, hydrogen, or combination thereof. Hydrogen may in some cases refer to majority hydrogen (H₂). For example, some portion of this hydrogen may also contain methane (e.g., unspent methane) or various other hydrocarbons (e.g., ethane, propane, ethylene, acetylene, benzene, toluene, polycyclic aromatic hydrocarbons (PAHs) such as naphthalene, etc.).

The present disclosure provides examples of such systems and methods, including, for example, the use of plasma technology in pyrolytic decomposition (e.g., pyrolytic dehydrogenation) of natural gas or renewable natural gas to carbonaceous material (e.g., solid carbonaceous material, such as, for example, carbon particles), hydrogen, or combination thereof. Pyrolytic decomposition (e.g., pyrolytic dehydrogenation) may refer to thermal decomposition of materials at elevated temperatures (e.g., temperatures greater than about 800° C.) in an inert or oxygen-free environment or atmosphere. The temperature of a reactor may be increased to increase the conversion of feedstock into carbon particles, hydrogen, or combination thereof. The temperature of a reactor can be increased to selectively produce hydrogen, carbon particles, or combinations thereof. The temperature of a reactor can be tuned to increase or decrease the surface area of carbon particles. Increasing reactor temperatures can increase the kinetic rates of feedstock decomposition as well as the intermediate operations which can produce formation of carbon particles and hydrogen. Increasing reactor temperatures also can increase the rate of carbon particle aging and can reduce reactor wall fouling. This may be due to reducing the time before the carbon particles are chemically inert.

Processes in accordance with the present disclosure may include heating one or more gases with electrical energy (e.g., from a direct current (DC) or alternating current (AC) power source). The electrical energy may be provided by one or more plasma generating electrodes disposed in the plasma generating section of a reactor. The one or more plasma generating electrodes may be configured to or may heat a thermal transfer gas in the plasma generating section. Any description of heating a gas or of heating one or more gases herein may equally apply to heating a gaseous mixture (e.g., at least 50% by volume gaseous) with a corresponding composition at least in some configurations. The gaseous mixture may comprise, for example, a mixture of individual gases, liquids, or a mixture of individual gas-liquid mixtures. Any description of a gas herein may equally apply to a liquid or gas-liquid mixture with a corresponding composition at least in some configurations. The one or more gases may be heated by an electric arc. The arc may be controlled through the use of a magnetic field which may move the arc in a circular fashion rapidly around the electrode tips. The electrodes may or may not be oriented parallel to an axis of the reactor or to each other. The electrodes may comprise a complex shape. A feedstock (e.g., a hydrocarbon feedstock) may be injected through various injector configurations. For example, the feedstock (e.g., the hydrocarbon feedstock) may be injected at an injector through the center or annulus of concentric electrodes, or at another location within the reactor.

The systems described herein may comprise plasma generators. The plasma generators may utilize a gas (e.g., thermal transfer gas) or gaseous mixture (e.g., at least 50% by volume gaseous). The plasma generators may utilize a gas or gaseous mixture (e.g., at least 50% by volume gaseous) where the gas is reactive and corrosive in the plasma state. The plasma generators may be plasma torches.

The systems described herein may comprise plasma generators energized by a DC or AC power source. The gas or gas mixture may be supplied directly into a zone in which an electric discharge produced by the DC or AC power source is sustained. The plasma may have a composition as described elsewhere herein (e.g., in relation to composition of the one or more gases). The plasma may be generated using electric arc heating. The plasma may be generated using inductive heating. The plasma may be generated using DC electrodes. The plasma may be generated using AC electrodes. For example, a plurality (e.g., 3 or more) of AC electrodes may be used (e.g., with the advantage of more efficient energy consumption as well as reduced heat load at the electrode surface). The plasma can be generated by heating a neutral gas (e.g., argon, carbon monoxide, carbon dioxide, or the like) to high temperature or subjecting it to a strong electromagnetic field, (e.g., at about 800 amperes and about 800 to 1000 volts, or similar magnitudes and values). The plasma may be generated in appreciable quantity only at or near the electric arc (e.g., at plasma torch tips). The material generated by the electric arc may be greater than or equal to about 5%, 10%, 20%, 30%, 40%, 50%, 60%, 70%, 80%, 90%, or more plasma. The material generated by the electric arc may be less than or equal to about 90%, 80%, 70%, 60%, 50%, 40%, 30%, 20%, 10%, 5%, or less plasma. The material generated by the electric arc may be plasma in a range as defined by any two of the preceding percentage values. For example, material generated by the electric arc may be in a range between about 5% and about 30% plasma. Alternatively, the one or more gases may be heated by Joule heating (e.g., resistive heating, induction heating, or a combination thereof). The one or more gases may be heated by Joule heating and by an electric arc (e.g., downstream of the Joule heating). The one or more gases may be heated by heat exchange, by Joule heating, by an electric arc, or any combination thereof. The one or more gases may be heated by heat exchange, by Joule heating, by combustion, or any combination thereof. At least one of the one or more gases may comprise a hydrocarbon. The one or more gases may include a feedstock. The one or more gases may include the feedstock alone or in combination with other gases (which other gases, alone or in combination with other gases which are not heated, may be referred to herein as “process gases”). The one or more gases may include the feedstock and at least one process gas. Individual gases among the one or more gases may be provided (e.g., to a reactor) separately or in various combinations. At least a subset of the one or more gases may be pre-heated. For example, the feedstock (e.g., the hydrocarbon or the hydrocarbon feedstock) may be pre-heated (e.g., from a temperature of about 25° C.) to a temperature from about 100° C. to about 800° C. prior to being provided to the thermal generator. The process may include heating at least a subset of the one or more gases (e.g., the feedstock) at suitable reaction conditions (e.g., in the reactor).

The carbonaceous material or hydrogen may be produced in a substantially inert or substantially oxygen-free environment or atmosphere. At least a subset of the one or more gases (e.g., the feedstock) may be heated in a substantially oxygen-free environment or atmosphere. A substantially oxygen-free environment or atmosphere may comprise, for example, less than or equal to about 10%, 9%, 8%, 7%, 6%, 5%, 4%, 3%, 2% or 1% molecular oxygen by volume or mole. A substantially oxygen-free environment or atmosphere may comprise, for example, greater than or equal to about 1%, 2%, 3%, 4%, 5%, 6%, 7%, 8%, 9%, or 10% atomic oxygen by volume or mole.

The heating may effect removal of hydrogen from the feedstock. The feedstock (e.g., one or more hydrocarbons) may be cracked by the heating such that at least about 80% by moles of the hydrogen originally chemically attached through covalent bonds to a hydrocarbon may become homoatomically bonded as diatomic hydrogen. Homoatomically bonded may refer to the bond being between two atoms that are the same (e.g., as in diatomic hydrogen (H₂)). C—H may be a heteroatomic bond. A hydrocarbon may go from heteroatomically bonded C—H to homoatomically bonded H—H (e.g., as in diatomic hydrogen (H₂)) and C—C (e.g., as in solid carbonaceous material). Reaction products may include an effluent stream of, for example, gases and solids that exit the reactor. The effluent stream comprising the reaction products may be cooled. The reaction products may be at least partially separated (e.g., after cooling). For example, solid carbonaceous material may be at least partially separated from the other (e.g., gaseous) reaction products.

A feedstock may be provided to the reactor. At least one process gas (e.g., any non-feedstock gas provided to a reactor in accordance with the present disclosure) may (e.g., also) be provided to the reactor. A hot gas may be generated (e.g., in the reactor or plasma generating section) through the use of a thermal generator (e.g., in an upper portion of the reactor or plasma generating section). For example, the hot gas may be generated in an upper portion of the reactor through the use of one or more AC electrodes (e.g., three or more AC electrodes), through the use of DC electrodes (e.g., concentric DC electrodes), or through the use of a resistive or inductive heater. The hot gas may be generated by heating at least a subset of one or more gases (e.g., a feedstock alone or in combination with at least one process gas) using the AC electrodes, the DC electrodes, or the resistive or inductive heater. The heating may include directly heating a feedstock (e.g., a hydrocarbon feedstock). For example, the feedstock (e.g., hydrocarbon feedstock) may be added to the thermal generator (e.g., at a pressure described elsewhere herein). For example, the feedstock (e.g., hydrocarbon feedstock) may be added through direct injection into the plasma. The reactor (or at least a portion thereof, such as, for example, at least a portion of an inner wall of the reactor) may comprise a liner (e.g., a refractory liner). A feedstock (e.g., hydrocarbon feedstock) may be provided to the reactor. For example, the feedstock (e.g., hydrocarbon feedstock) may be injected into the reactor through one or more injectors. Alternatively, or in addition, the feedstock (e.g., hydrocarbon feedstock) may be provided through one or more inlet ports (e.g., in a wall of the reactor).

Any description as to number or location of injectors herein may equally apply to inlet ports at least in some configurations, and vice versa. One or more process gases may be provided through one or more inlet ports (e.g., the same or different than the hydrocarbon or feedstock) or through at least a subset of the one or more injectors. A given process gas may be provided together with a feedstock, separately from the feedstock, or a combination thereof (e.g., the given process gas may be provided with the feedstock, and either the given process gas or a different process gas may be provided separately from the feedstock (e.g., as purge)). A given process gas may or may not be heated by the thermal generator.

A process gas provided with the feedstock or in parallel with the feedstock may be heated. A process gas may modify the environment or atmosphere in or around at least a portion of the reactor, the thermal generator, inlet port(s), or injector(s), purge at least a portion of the reactor, the thermal generator, inlet port(s) or injector(s), or any combination thereof. For example, an inlet port, an array of inlet ports or a plenum (e.g., at the top of a reactor) may be used to purge at least a portion of the reactor (e.g., one or more walls), one or more other inlet ports, or one or more injectors (e.g., as described in greater detail elsewhere herein). Any description of an inlet port herein may equally apply to an array of inlet ports or a plenum at least in some configurations, and vice versa. The one or more gases (e.g., a feedstock alone or in combination with at least one process gas) that are heated with electrical energy may comprise substantially only the hydrocarbon (e.g., the feedstock). For example, the one or more gases that are heated with electrical energy may comprise the feedstock, and either no process gases, or process gas(es) at purge level(s) or some process gas(es) added with the feedstock (e.g., the one or more gases that are heated with electrical energy may comprise the feedstock and process gas(es) at purge level(s)). As the hydrocarbon (e.g., feedstock) that is heated comprises substantially only freshly supplied hydrocarbon, such a configuration may be referred to herein as a “once-through process.” Alternatively, the one or more gases that are heated with electrical energy may comprise greater level(s) of process gas(es). Levels of a given process gas or a sum of a subset or of all process gases (e.g., on a per mole of feedstock basis) and percentage of process gas(es) heated with electrical energy may be as described elsewhere herein. In some cases, where DC electrodes are used, two electrodes can be used. In some cases, where DC electrodes are used, a multiple of two electrodes can be used (e.g., 2, 4, 6, etc.). AC electrodes may be used in single phase or triple phase configurations. When a single phase AC configuration is used, a multiple of two electrodes may be used (e.g., 2, 4, 6, 8, etc.). When a triple phase AC configuration is used, a multiple of 3 electrodes can be used (e.g., 3, 6, 9, etc.). Each electrode can have an associated injector. For example, a triple phase three electrode configuration can comprise three injectors positioned above the plane of the electrodes.

The electrodes may be cylindrical in shape. The electrodes may be movable via a screw system working in concert with the sliding seal associated with the electrode. The screw system may be water cooled. Use of the movable electrodes may enable continuous operation of the reactor. For example, additional electrode material can be joined to the ends of the electrodes outside of the reactor and, as the electrodes are degraded in the reactor, new electrode material can be fed into the reactor. In this example, the ability to add new electrode material outside of the reactor during reactor operation can provide for continuous or substantially continuous operation of the reactor. In some cases, the electrodes comprise graphite (e.g., synthetic graphite, natural graphite, semi graphite, etc.), carbonaceous materials and resins or other binders, carbon composite materials, carbon fiber materials, or the like, or any combination thereof. The electrodes may be at least about 1, 2, 3, 4, 5, 6, 7, 8, 9, 10, 11, 12, 13, 14, 15, 16, 17, 18, 19, 20, 21, 22, 23, 24, 25, 26, 27, 28, 29, 30, 35, 40, or more inches in diameter. The electrodes may be at most about 40, 35, 30, 29, 28, 27, 26, 25, 24, 23, 22, 21, 20, 19, 18, 17, 16, 15, 14, 13, 12, 11, 10, 9, 8, 7, 6, 5, 4, 3, 2, 1, or fewer inches in diameter. The electrodes may be at least about 1, 2, 3, 4, 5, 6, 7, 8, 9, 10, 11, 12, 13, 14, 15, 16, 17, 18, 19, 20, 21, 22, 23, 24 or more feet in length. The electrodes may be at most about 24, 23, 22, 21, 20, 19, 18, 17, 16, 15, 14, 13, 12, 11, 10, 9, 8, 7, 6, 5, 4, 3, 2, 1, or less feet in length. The distance between the center point of the electrode arc and the wall of the reactor may be at least about 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, or more meters. The distance between the center point of the electrode arc and the wall of the reactor may be at most about 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, or fewer meters. Too great of a distance can generate recirculation of gases back into the plasma region, while too short of a distance can cause the wall of the reactor to degrade. In some cases, an electrode can have a mass of at least about 20, 100, 200, 300, 400, 500, 600, 700, 800, 900, 1,000, 10,000, 20,000, 30,000 40,000, or more kilograms. In some cases, an electrode can have a mass of at most about 40,000, 30,000, 20,000, 10,000, 1,000, 900, 800, 700, 600, 500, 400, 300, 200, 100, 20, or fewer kilograms.

Electrodes (e.g., AC or DC electrodes of a plasma generator) in accordance with the present disclosure (or portions thereof) may be placed at a given distance (also “gap” or “gap size” herein) from each other. The gap between the electrodes (or portions thereof) may be, for example, less than or equal to about 40 millimeters (mm), 39 mm, 38 mm, 37 mm, 36 mm, 35 mm, 34 mm, 33 mm, 32 mm, 31 mm, 30 mm, 29 mm, 28 mm, 27 mm, 26 mm, 25 mm, 24 mm, 23 mm, 22 mm, 21 mm, 20 mm, 19 mm, 18 mm, 17 mm, 16 mm, 15 mm, 14 mm, 13 mm, 12 mm, 11 mm, 10 mm, 9 mm, 8 mm, 7 mm, 6 mm, 5 mm, 4 mm, 3 mm, 2 mm, or 1 mm. Alternatively, or in addition, the gap between the electrodes (or portions thereof) may be, for example, greater than or equal to about 0.5 mm, 1 mm, 2 mm, 3 mm, 4 mm, 5 mm, 6 mm, 7 mm, 8 mm, 9 mm, 10 mm, 11 mm, 12 mm, 13 mm, 14 mm, 15 mm, 16 mm, 17 mm, 18 mm, 19 mm, 20 mm, 21 mm, 22 mm, 23 mm, 24 mm, 25 mm, 26 mm, 27 mm, 28 mm, 29 mm, 30 mm, 31 mm, 32 mm, 33 mm, 34 mm, or 35 mm.

The hydrocarbon (e.g., feedstock) may be injected adjacent to one or more electrodes. The hydrocarbon may be injected in close proximity to one or more electrodes. In some cases, the hydrocarbon may be injected at a distance from the electrodes in a range of about 1 mm to about 1,000 mm. In some cases, the hydrocarbon may be injected at a distance from the electrodes in a range of about 1 mm to about 5 mm, about 1 mm to about 10 mm, about 1 mm to about 100 mm, about 1 mm to about 1,000 mm, about 5 mm to about 10 mm, about 5 mm to about 100 mm, about 5 mm to about 1,000 mm, about 10 mm to about 100 mm, about 10 mm to about 1,000 mm, or about 100 mm to about 1,000 mm. In some cases, the hydrocarbon is injected at a distance from the electrodes of about 1 mm, about 5 mm, about 10 mm, about 100 mm, or about 1,000 mm. In some cases, the hydrocarbon is injected at a distance from the electrodes of at least about 1 mm, about 5 mm, about 10 mm, or about 100 mm. In some cases, the hydrocarbon is injected at a distance from the electrodes of at most about 5 mm, about 10 mm, about 100 mm, or about 1,000 mm.

Alternatively, or in addition, the hydrocarbon (e.g., feedstock) may be injected into the carbon particle generating section of the reactor. The carbon particle generating section may comprise one or more hydrocarbon injectors through which the hydrocarbon is injected. The carbon particle generating section may comprise greater than or equal to 1, 2, 3, 4, 6, 8, 10, 12, or more injectors.

The pressure at the tip of any of the injectors may be the same as the pressure of the surrounding reactor. In some cases, the pressure at the tip of any of the injectors is greater than the pressure of the surrounding reactor. In some cases, the pressure at the tip of any of the injectors is within about 20% of the pressure of the surrounding reactor. In some cases, the pressure at the tip of any of the injectors is within about 10% of the pressure of the surrounding reactor. In some cases, the pressure at the tip of any of the injectors is within about 5% of the pressure of the surrounding reactor. In some cases, the pressure at the tip of any of the injectors is within about 1% of the pressure of the surrounding reactor.

The electrodes, injectors, or both may possess an angle of inclination (e.g., an angle between the long axis of the electrode or injector and the long axis of the reactor) of at least about 0, 5, 10, 15, 20, 25, 30, 35, 40, 45, 50, 55, 60, 65, 70, 75, 80, 85, 90, or more degrees. The electrodes or the injectors may possess an angle of inclination of at most about 90, 85, 80, 75, 70, 65, 60, 55, 50, 45, 40, 35, 30, 25, 20, 15, 10, 5, 0, or less degrees. The electrodes or the injectors may possess an angle of inclination in a range as defined by any two of the preceding values. For example, the electrodes and the injectors may have an angle of inclination between about 15 and about 30 degrees. Higher angles of inclination may provide increased torch stability. The injectors may comprise a heat resistant material (e.g., metals, tungsten, graphite, metal carbides, ceramic materials, alumina, silica, aluminosilicates, glasses, etc.). For example, the injectors can be formed of metal (e.g., copper, stainless steel, Inconel, etc.). The injectors may be water cooled. The injectors may be configured to provide additional additives in addition to the feedstocks to the reactor.

The reactor may comprise one or more optional sheath gas injectors. The sheath gas injectors may be configured to provide an inert gas configured to provide a barrier to fouling within the reactor chamber. The inert gas may be as described elsewhere herein. The sheath gas may be located on an interior surface of the reactor. The sheath gas may be located higher upstream than the electrode tips. The sheath gas may be introduced to the reactor, for example, via a slit around the circumference of the reactor configured to enable gas flow out of the slit into close proximity to the interior surface of the reactor.

Injectors in accordance with the present disclosure (or portions thereof) may comprise or be made of one or more suitable materials, such as, for example, copper, stainless steel, graphite, alloys (e.g., of high temperature corrosion resistant metals), other similar materials (e.g., with high melting points and good corrosion resistance), or combinations thereof. The injector(s) may be cooled via a cooling fluid. The injector(s) may be cooled by, for example, water or a non-oxidizing liquid (e.g., mineral oil, ethylene glycol, propylene glycol, synthetic organic fluids such as, for example, DOWTHERM™ materials, etc.).

Thermal generators (e.g., plasma generators) or reactors of the present disclosure (or portions thereof) may comprise or be made of, for example: copper, tungsten, graphite (e.g., extruded or molded), molybdenum, rhenium, nickel, chromium, iron, silver, other refractory or high temperature metals, or alloys thereof (e.g., copper-tungsten alloy, rhenium-tungsten alloy, molybdenum-tungsten alloy or copper-rhenium alloy; carbide alloys such as, for example, tungsten carbide, molybdenum carbide or chromium carbide; etc.); boron nitride, silicon carbide, alumina, alumina silica blends, or other high temperature ceramics; other oxygen-resistant refractory material; or any combination thereof. At least a portion of an electrode(s) of a thermal generator (e.g., plasma generator) may comprise one or more of the aforementioned materials. An electrode in accordance with the present disclosure may have a suitable geometry (e.g., cylindrical, bar with an ellipsoid or polygonal cross-section, sharp or rounded ends, etc.). The electrode geometry may be customized. Alternatively, the thermal generator may be configured to allow integration of existing electrode geometries (e.g., used in steelmaking). The electrode material (e.g., chemical composition, grain structure, etc.) or geometry may be configured to enhance survivability (e.g., strength, thermal flexibility, etc.). At least a portion of a reactor (e.g., at least a portion of a wall or liner) in accordance with the present disclosure may comprise one or more of the aforementioned materials (e.g., the reactor may be refractory-lined). The reactor (e.g., wall or liner of the reactor) may comprise one or more sections comprising different materials. For example, the refractory liner may comprise one or more sections comprising different refractory materials, such as, for example, a section that may be too hot for a given refractory material and another section comprising the given (e.g., standard) refractory material.

A thermal generator (e.g., plasma generator) in accordance with the present disclosure may be configured such that, for example, less than or equal to about 750 kilograms (kg), 500 kg, 400 kg, 300 kg, 200 kg, 100 kg, 90 kg, 80 kg, 70 kg, 60 kg, 50 kg, 40 kg, 30 kg, 20 kg, 15 kg, 10 kg, 5 kg, 2 kg, 1.75 kg, 1.5 kg, 1.25 kg, 1 kg, 0.9 kg, 0.8 kg, 0.7 kg, 0.6 kg, 500 grams (g), 400 g, 300 g, 200 g, 100 g, 50 g, 20 g, 10 g, 5 g, 2 g or 1 g of electrode material is consumed per ton (e.g., metric ton) of carbonaceous material (e.g., solid carbonaceous material) produced. Alternatively, or in addition, the thermal generator (e.g., plasma generator) of the present disclosure may be configured such that, for example, greater than or equal to about 0 g, 1 g, 1.25 kg, 1.5 kg, 1.75 kg, 2 g, 5 g, 10 g, 20 g, 50 g, 100 g, 200 g, 300 g, 400 g, 500 g, 0.6 kg, 0.7 kg, 0.8 kg, 0.9 kg, 1 kg, 2 kg, 5 kg, 10 kg, 15 kg, 20 kg, 30 kg, 40 kg, 50 kg, 60 kg, 70 kg, 80 kg, 90 kg, 100 kg, 200 kg, 300 kg, 400 kg or 500 kg of electrode material is consumed per ton (e.g., metric ton) of carbonaceous material (e.g., solid carbonaceous material) produced.

The hydrocarbon feedstock may include any chemical with formula CₙHₓ or CₙHₓO_{y}, where n is an integer; x is between (i) 1 and 2n+2 or (ii) less than 1 for fuels such as coal, coal tar, pyrolysis fuel oils, and the like; and y is between 0 and n. The hydrocarbon feedstock may include, for example, simple hydrocarbons (e.g., methane, ethane, propane, butane, etc.), aromatic feedstocks (e.g., benzene, toluene, ethylbenzene, xylene, methyl naphthalene, pyrolysis fuel oil, coal tar, coal, heavy oil, oil, bio-oil, bio-diesel, other biologically derived hydrocarbons, and the like), unsaturated hydrocarbons (e.g., ethylene, acetylene, butadiene, styrene, and the like), oxygenated hydrocarbons (e.g., ethanol, methanol, propanol, phenol, ketones, ethers, esters, and the like), or any combination thereof. These examples are provided as non-limiting examples of acceptable hydrocarbon feedstocks which may be further combined or mixed with other components for manufacture. A hydrocarbon feedstock may refer to a feedstock in which the majority of the feedstock (e.g., more than about 50% by mass) is hydrocarbon (e.g., hydrocarbon and/or hydrocarbon derivative) in nature. The reactive hydrocarbon feedstock may comprise at least about 70% by mass methane, ethane, propane or mixtures thereof. The hydrocarbon feedstock may comprise or be natural gas or renewable natural gas. The hydrocarbon feedstock may comprise or be methane, ethane, propane or mixtures thereof. The hydrocarbon feedstock may comprise methane, ethane, propane, butane, acetylene, ethylene, carbon black oil, coal tar, crude coal tar, diesel oil, benzene or methyl naphthalene. The hydrocarbon feedstock may comprise (e.g., additional) polycyclic aromatic hydrocarbons. The hydrocarbon feedstock may comprise one or more simple hydrocarbons, one or more aromatic feedstocks, one or more unsaturated hydrocarbons, one or more oxygenated hydrocarbons, one or more hydrocarbon derivatives, or any combination thereof. The hydrocarbon feedstock may comprise, for example, methane, ethane, propane, butane, pentane, natural gas, benzene, toluene, xylene, ethylbenzene, naphthalene, methyl naphthalene, dimethyl naphthalene, anthracene, methyl anthracene, other monocyclic or polycyclic aromatic hydrocarbons, carbon black oil, diesel oil, pyrolysis fuel oil, coal tar, crude coal tar, coal, heavy oil, oil, bio-oil, bio-diesel, other biologically derived hydrocarbons, ethylene, acetylene, propylene, butadiene, styrene, ethanol, methanol, propanol, phenol, one or more ketones, one or more ethers, one or more esters, one or more aldehydes, or any combination thereof. The hydrocarbon feedstock may comprise one or more derivatives of feedstock compounds described herein, such as, for example, benzene or its derivative(s), naphthalene or its derivative(s), anthracene or its derivative(s), etc. The hydrocarbon feedstock (also “feedstock” herein) may comprise a given feedstock (e.g., among the aforementioned feedstocks) at a concentration (e.g., in a mixture of feedstocks) greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by mass, volume, or mole. Alternatively, or in addition, the feedstock may comprise the given feedstock at a concentration (e.g., in a mixture of feedstocks) less than or equal to about 100% 99%, 95%, 90%, 85%, 80%, 75%, 70%, 65%, 60%, 55%, 50%4, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4%, 5%, 4% 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by mass, volume, or mole. The feedstock may comprise additional feedstocks (e.g., in a mixture of feedstocks) at similar or different concentrations. Such additional feedstocks may be selected, for example, among the aforementioned feedstocks not selected as the given feedstock. The given feedstock may itself comprise a mixture (e.g., such as natural gas or renewable natural gas).

A process gas may comprise, for example, oxygen, nitrogen, argon, helium, air, hydrogen, carbon monoxide, water, hydrocarbon (e.g., methane, ethane, unsaturated or any hydrocarbon described herein in relation to the feedstock), etc. (used alone or in mixtures of two or more). In some examples, a process gas may be inert. A process gas may comprise or be freshly supplied gas (e.g., delivered, or supplied from storage such as, for example, a cylinder or a container), recycled gaseous reaction products (e.g., as described in greater detail elsewhere herein), or any combination thereof. The process gas may comprise, for example, oxygen, nitrogen (e.g., up to about 30% by volume), argon (Ar) (e.g., up to about 30% by volume), helium, air, hydrogen (e.g., greater than or equal to about 50%, 60%, 70%, 80% and 90%, up to about 100% by volume), carbon monoxide (e.g., at least about 1 ppm by volume and up to about 30%), water, hydrocarbon (e.g., methane, ethane, unsaturated, benzene and toluene or similar monoaromatic hydrocarbon, polycyclic aromatic hydrocarbon such as anthracene and its derivatives, naphthalene and its derivatives, methyl naphthalene, methyl anthracene, coronene, pyrene, chrysene, fluorene and the like, or any hydrocarbon described herein in relation to the feedstock; for example, at least about 1 ppm by volume and up to about 30% methane (CH₄) by volume, at least about 1 ppm by volume and up to about 30% acetylene (C₂H₂) by volume, at least about 1 ppm ethylene (C₂H₄) by volume, at least about 1 ppm benzene by volume, or at least about 1 ppm polyaromatic hydrocarbon by volume), hydrogen cyanide (HCN) (e.g., at least about 1 ppm by volume and up to about 10% by volume), ammonia (NH₃) (e.g., at least about 1 ppm by volume and up to about 10% by volume), etc. (used alone or in mixtures of two or more). The process gas may comprise at least about 60% hydrogen up to about 100% hydrogen (by volume) and may further comprise up to about 30% nitrogen, up to about 30% carbon monoxide (CO), up to about 30% CH₄, up to about 10% HCN, up to about 30% C₂H₂, and up to about 30% Ar. For example, the process gas may be greater than about 60% hydrogen. Additionally, the process gas may also comprise polycyclic aromatic hydrocarbons such as anthracene, naphthalene, coronene, pyrene, chrysene, fluorene, and the like. In addition, the process gas may have benzene and toluene or similar monoaromatic hydrocarbon components present. For example, the process gas may comprise greater than or equal to about 90% hydrogen, and about 0.2% nitrogen, about 1.0% CO, about 1.1% CH₄, about 0.1% HCN and about 0.1% C₂H₂. The process gas may comprise greater than or equal to about 80% hydrogen and the remainder may comprise some mixture of the aforementioned gases, polycyclic aromatic hydrocarbons, monoaromatic hydrocarbons and other components. The process gas may comprise greater than or equal to about 50% hydrogen by volume. The process gas may comprise greater than about 70% H₂ by volume and may include at least one or more of the gases HCN, CH₄, C₂H₄, C₂H₂, CO, benzene or polyaromatic hydrocarbon (e.g., naphthalene or anthracene) at a level of at least about 1 ppm. The polyaromatic hydrocarbon may comprise, for example, naphthalene, anthracene or their derivatives. The polyaromatic hydrocarbon may comprise, for example, methyl naphthalene or methyl anthracene. The process gas may comprise a given process gas (e.g., among the aforementioned process gases) at a concentration (e.g., in a mixture of process gases) greater than or equal to about 1 ppm, 5 ppm, 10 ppm, 25 ppm, 50 ppm, 0.01%, 0.05%, 0.1%, 0.2%, 0.3%, 0.4%, 0.5%, 0.6%, 0.7%, 0.8%, 0.9%, 1%, 1.1%, 1.2%, 1.3%, 1.4%, 1.5%, 1.6%, 1.7%, 1.8%, 1.9%, 2%, 2.5%, 3%, 3.5%, 4%, 4.5%, 5%, 6%, 7%, 8%, 9%, 10%, 11%, 12%, 13%, 14%, 15%, 16%, 17%, 18%, 19%, 20%, 21%, 22%, 23%, 24%, 25%, 26%, 27%, 28%, 29%, 30%, 31%, 32%, 33%, 34%, 35%, 36%, 37%, 38%, 39%, 40%, 41%, 42%, 43%, 44%, 45%, 46%, 47%, 48%, 49%, 50%, 55%, 60%, 65%, 70%, 75%, 80%, 85%, 90%, 95% or 99% by mass, volume, or mole. Alternatively, or in addition, the process gas may comprise the given process gas at a concentration (e.g., in a mixture of process gases) less than or equal to about 100%, 99%, 95%, 90%, 85%, 80%, 75%, 70%, 65%, 60%, 55%, 50%, 49%, 48%, 47%, 46%, 45%, 44%, 43%, 42%, 41%, 40%, 39%, 38%, 37%, 36%, 35%, 34%, 33%, 32%, 31%, 30%, 29%, 28%, 27%, 26%, 25%, 24%, 23%, 22%, 21%, 20%, 19%, 18%, 17%, 16%, 15%, 14%, 13%, 12%, 11%, 10%, 9%, 8%, 7%, 6%, 5%, 4.5%, 4%, 3.5%, 3%, 2.5%, 2%, 1.9%, 1.8%, 1.7%, 1.6%, 1.5%, 1.4%, 1.3%, 1.2%, 1.1%, 1%, 0.9%, 0.8%, 0.7%, 0.6%, 0.5%, 0.4%, 0.3%, 0.2%, 0.1%, 0.05%, 0.01%, 50 ppm, 25 ppm, 10 ppm, 5 ppm or 1 ppm by mass, volume, or mole. The process gas may comprise additional process gases (e.g., in a mixture of process gases) at similar or different concentrations. Such additional process gases may be selected, for example, among the aforementioned process gases not selected as the given process gas. The given process gas may itself comprise a mixture. The process gas may be used as a purge gas. The purge gas may be an inert gas used to purge a reactor or carbon particles (e.g., to remove non-inert gases). The purge gas may be provided at a pressure greater than an operating pressure of the reactor (e.g., the purge gas may be provided at a higher pressure and regulated to a lower pressure in the reactor).

The feedstock (e.g., hydrocarbon feedstock) may be provided to the system at a rate of, for example, greater than or equal to about 50 grams per hour (g/hr), 100 g/hr, 250 g/hr, 500 g/hr, 750 g/hr, 1 kilogram per hour (kg/hr), 2 kg/hr, 5 kg/hr, 10 kg/hr, 15 kg/hr, 20 kg/hr, 25 kg/hr, 30 kg/hr, 35 kg/hr, 40 kg/hr, 45 kg/hr, 50 kg/hr, 55 kg/hr, 60 kg/hr, 65 kg/hr, 70 kg/hr, 75 kg/hr, 80 kg/hr, 85 kg/hr, 90 kg/hr, 95 kg/hr, 100 kg/hr, 150 kg/hr, 200 kg/hr, 250 kg/hr, 300 kg/hr, 350 kg/hr, 400 kg/hr, 450 kg/hr, 500 kg/hr, 600 kg/hr, 700 kg/hr, 800 kg/hr, 900 kg/hr, 1,000 kg/hr, 1,100 kg/hr, 1,200 kg/hr, 1,300 kg/hr, 1,400 kg/hr, 1,500 kg/hr, 1,600 kg/hr, 1,700 kg/hr, 1,800 kg/hr, 1,900 kg/hr, 2,000 kg/hr, 2,100 kg/hr, 2,200 kg/hr, 2,300 kg/hr, 2,400 kg/hr, 2,500 kg/hr, 3,000 kg/hr, 3,500 kg/hr, 4,000 kg/hr, 4,500 kg/hr, 5,000 kg/hr, 6,000 kg/hr, 7,000 kg/hr, 8,000 kg/hr, 9,000 kg/hr, 10,000 kg/hr, or more. Alternatively, or in addition, the feedstock (e.g., hydrocarbon) may be provided to the system (e.g., to the reactor) at a rate of, for example, less than or equal to about 10,000 kg/hr, 9,000 kg/hr, 8,000 kg/hr, 7,000 kg/hr, 6,000 kg/hr, 5,000 kg/hr, 4,500 kg/hr, 4,000 kg/hr, 3,500 kg/hr, 3,000 kg/hr, 2,500 kg/hr, 2,400 kg/hr, 2,300 kg/hr, 2,200 kg/hr, 2,100 kg/hr, 2,000 kg/hr, 1,900 kg/hr, 1,800 kg/hr, 1,700 kg/hr, 1,600 kg/hr, 1,500 kg/hr, 1,400 kg/hr, 1,300 kg/hr, 1,200 kg/hr, 1,100 kg/hr, 1,000 kg/hr, 900 kg/hr, 800 kg/hr, 700 kg/hr, 600 kg/hr, 500 kg/hr, 450 kg/hr, 400 kg/hr, 350 kg/hr, 300 kg/hr, 250 kg/hr, 200 kg/hr, 150 kg/hr, 100 kg/hr, 95 kg/hr, 90 kg/hr, 85 kg/hr, 80 kg/hr, 75 kg/hr, 70 kg/hr, 65 kg/hr, 60 kg/hr, 55 kg/hr, 50 kg/hr, 45 kg/hr, 40 kg/hr, 35 kg/hr, 30 kg/hr, 25 kg/hr, 20 kg/hr, 15 kg/hr, 10 kg/hr, 5 kg/hr, 2 kg/hr, 1 kg/hr, 750 g/hr, 500 g/hr, 250 g/hr, 100 g/hr, or less.

A dilution may be a ratio of a total number of moles of process gas (e.g., dilutant gas) to the total number of moles of carbon atoms (e.g., feedstock carbon atoms) injected into a reactor (e.g., during a process described elsewhere herein). A dilution factor below about 2 may provide benefits in the operation of a plasma-based pyrolysis reactor. Achieving a dilution factor below about 2 may comprise use of a hydrocarbon as a plasma gas. For example, the hydrocarbon may be used as both the plasma gas and the feedstock gas. A reactor with a dilution factor below about 2 may have recycle and purge gases in close vicinity of the electrodes in amounts that provide a dilution factor below about 2. The purge gases may be present to pressurize the reactor or pressurize sliding seals on the electrodes of the reactor. The apparatuses and methods of the present disclosure may achieve a dilution factor of at least about 0, 0.1, 0.2, 0.3, 0.4, 0.5, 0.6, 0.7, 0.8, 0.9, 1, 1.1, 1.2, 1.3, 1.4, 1.5, 1.6, 1.7, 1.8, 1.9, 2, 2.1, 2.2, 2.3, 2.4, 2.5, 2.6, 2.7, 2.8, 2.9, 3, 3.1, 3.2, 3.3, 3.4, 3.5, 3.6, 3.7, 3.8, 3.9, 4, or more. The apparatuses and methods of the present disclosure may achieve a dilution factor of at most about 4, 3.9, 3.8, 3.7, 3.6, 3.5, 3.4, 3.3, 3.2, 3.1, 3, 2.9, 2.8, 2.7, 2.6, 2.5, 2.4, 2.3, 2.2, 2.1, 2, 1.9, 1.8, 1.7, 1.6, 1.5, 1.4, 1.3, 1.2, 1.1, 1, 0.9, 0.8, 0.7, 0.6, 0.5, 0.4, 0.3, 0.2, 0.1, or less.

A recycle gas may be supplied to the systems and methods of the present disclosure. The recycle gas may be at least a component of a plasma gas. For example, the recycle gas may be provided to a reactor to be heated as a portion of the plasma gas. The recycle gas may be a process gas as described elsewhere herein. The recycle gas may be at least a portion of a gas that is produced by a reactor. For example, the recycle gas may be the gas output by the reactor during the generation of carbon particles or hydrogen. The recycle gas may comprise hydrogen (e.g., at least about 10, 20, 30, 40, 50, 60, 70, 80, 90, 99, or more percent hydrogen), nitrogen, argon, carbon monoxide, water, hydrocarbons, or the like, or any combination thereof. The recycle gas may be gas rejected from a purification process as described elsewhere herein. For example, impurities removed from the hydrogen generated in a high pressure degas apparatus can be used as a recycle gas. The recycle gas may be at an elevated (e.g., above ambient) temperature. For example, the recycle gas may be provided at a high temperature to reduce the amount of energy lost from the plasma in heating the recycle gas. The use of the recycle gas may provide increased lifetime of the electrodes in a reactor as well as increased efficiency by recycling reactants (e.g., hydrocarbons) back into the reactor. For example, hydrocarbons can be recycled back into the reactor, thereby improving the conversion rate of the hydrocarbons. The recycle gas may be introduced into the reactor via a sheath or blanket flow of recycled gas or another inert gas as described elsewhere herein. Such a flow can prevent deposition of gaseous or solid carbon onto the electrodes or other surfaces of the reactor (e.g., reactor walls). In some cases, the recycle gas may be pressurized (e.g., repressurized) prior to introduction into the reactor. For example, the recycle gas may be passed through a compressor prior to being injected into the reactor. The recycle gas may be pressurized to the pressures described elsewhere herein.

A given process gas or a sum of a subset or of all process gases may be provided to the system at a rate of, for example, greater than or equal to about 0 normal cubic meter/hour (Nm³/hr), 0.1 Nm³/hr, 0.2 Nm³/hr, 0.5 Nm³/hr, 1 Nm³/hr, 1.5 Nm³/hr, 2 Nm³/hr, 5 Nm³/hr, 10 Nm³/hr, 25 Nm³/hr, 50 Nm³/hr, 75 Nm³/hr, 100 Nm³/hr, 150 Nm³/hr, 200 Nm³/hr, 250 Nm³/hr, 300 Nm³/hr, 350 Nm³/hr, 400 Nm³/hr, 450 Nm³/hr, 500 Nm³/hr, 550 Nm³/hr, 600 Nm³/hr, 650 Nm³/hr, 700 Nm³/hr, 750 Nm³/hr, 800 Nm³/hr, 850 Nm³/hr, 900 Nm³/hr, 950 Nm³/hr, 1,000 Nm³/hr, 2,000 Nm³/hr, 3,000 Nm³/hr, 4,000 Nm³/hr, 5,000 Nm³/hr, 6,000 Nm³/hr, 7,000 Nm³/hr, 8,000 Nm³/hr, 9,000 Nm³/hr, 10,000 Nm³/hr, 12,000 Nm³/hr, 14,000 Nm³/hr, 16,000 Nm³/hr, 18,000 Nm³/hr, 20,000 Nm³/hr, 30,000 Nm³/hr, 40,000 Nm³/hr, 50,000 Nm³/hr, 60,000 Nm³/hr, 70,000 Nm³/hr, 80,000 Nm³/hr, 90,000 Nm³/hr or 15,000 Nm³/hr. Alternatively, or in addition, the given process gas or a sum of a subset or of all process gases may be provided to the system (e.g., to the reactor) at a rate of, for example, less than or equal to about 100,000 Nm³/hr, 90,000 Nm³/hr, 80,000 Nm³/hr, 70,000 Nm³/hr, 60,000 Nm³/hr, 50,000 Nm³/hr, 40,000 Nm³/hr, 30,000 Nm³/hr, 20,000 Nm³/hr, 18,000 Nm³/hr, 16,000 Nm³/hr, 14,000 Nm³/hr, 12,000 Nm³/hr, 10,000 Nm³/hr, 9,000 Nm³/hr, 8,000 Nm³/hr, 7,000 Nm³/hr, 6,000 Nm³/hr, 5,000 Nm³/hr, 4,000 Nm³/hr, 3,000 Nm³/hr, 2,000 Nm³/hr, 1,000 Nm³/hr, 950 Nm³/hr, 900 Nm³/hr, 850 Nm³/hr, 800 Nm³/hr, 750 Nm³/hr, 700 Nm³/hr, 650 Nm³/hr, 600 Nm³/hr, 550 Nm³/hr, 500 Nm³/hr, 450 Nm³/hr, 400 Nm³/hr, 350 Nm³/hr, 300 Nm³/hr, 250 Nm³/hr, 200 Nm³/hr, 150 Nm³/hr, 100 Nm³/hr, 75 Nm³/hr, 50 Nm³/hr, 25 Nm³/hr, 10 Nm³/hr, 5 Nm³/hr, 2 Nm³/hr, 1.5 Nm³/hr, 1 Nm³/hr, 0.5 Nm³/hr or 0.2 Nm³/hr. The given process gas or a sum of a subset or of all process gases may be provided to the system (e.g., to the reactor) at such rates in combination with one or more feedstock flow rates described herein. A given process gas or a sum of a subset or of all process gases may be provided to the system at a ratio of, for example, greater than or equal to about 0, 0.0005, 0.001, 0.002, 0.005, 0.1, 0.2, 0.5, 1, 2, 3, 4, 5, 6, 7, 8, 9, 10, 15, 20, 25, 30, 35, 40, 45, 50, 75, or 90 moles of process gas(es) per mole of feedstock. Alternatively, or in addition, the given process gas or a sum of a subset or of all process gases may be provided to the system at a ratio of, for example, less than or equal to about 100, 90, 75, 50, 45, 40, 35, 30, 25, 20, 15, 10, 9, 8, 7, 6, 5, 4, 3, 2, 1, 0.5, 0.2, 0.1, 0.005, 0.002, 0.001, or 0.0005 moles of process gas(es) per mole of feedstock. Less than or equal to about 100%, 75%, 50%, 40%, 30%, 20%, 10%, 5%, or 1% of the process gas(es) provided to the system may be heated with electrical energy. Alternatively, or in addition, greater than or equal to about 0%, 1%, 5%, 10%, 20%, 30%, 40%, 50% or 75% of the process gas(es) provided to the system may be heated with electrical energy.

The one or more gases (e.g., the feedstock alone or in combination with at least one process gas) may be heated at a given pressure. The feedstock (e.g., alone or in combination with at least one process gas) may react at the given pressure. The heating and reaction may be implemented in a reactor at the given pressure (also “reactor pressure” herein). The pressure may be, for example, greater than or equal to about 0 bar, 0.5 bar, 1 bar, 1.1 bar, 1.2 bar, 1.3 bar, 1.4 bar, 1.5 bar, 1.6 bar, 1.7 bar, 1.8 bar, 1.9 bar, 2 bar, 2.1 bar, 2.2 bar, 2.3 bar, 2.4 bar, 2.5 bar, 2.6 bar, 2.7 bar, 2.8 bar, 2.9 bar, 3 bar, 3.1 bar, 3.2 bar, 3.3 bar, 3.4 bar, 3.5 bar, 3.6 bar, 3.7 bar, 3.8 bar, 3.9 bar, 4 bar, 4.5 bar, 5 bar, 6 bar, 7 bar, 8 bar, 9 bar, 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 35 bar, 40 bar, 45 bar, 50 bar, 55 bar, 60 bar, 65 bar, 70 bar, 75 bar, or more. Alternatively, or in addition, the pressure may be, for example, less than or equal to about 100 bar, 90 bar, 80 bar, 75 bar, 70 bar, 65 bar, 60 bar, 55 bar, 50 bar, 45 bar, 40 bar, 35 bar, 30 bar, 29 bar, 28 bar, 27 bar, 26 bar, 25 bar, 24 bar, 23 bar, 22 bar, 21 bar, 20 bar, 19 bar, 18 bar, 17 bar, 16 bar, 15 bar, 14 bar, 13 bar, 12 bar, 11 bar, 10 bar, 9 bar, 8 bar, 7 bar, 6 bar, 5 bar, 4 bar, 3.9 bar, 3.8 bar, 3.7 bar, 3.6 bar, 3.5 bar, 3.4 bar, 3.3 bar, 3.2 bar, 3.1 bar, 3 bar, 2.9 bar, 2.8 bar, 2.7 bar, 2.6 bar, 2.5 bar, 2.4 bar, 2.3 bar, 2.2 bar, 2.1 bar, 2 bar, 1.9 bar, 1.8 bar, 1.7 bar, 1.6 bar, 1.5 bar, 1.4 bar, 1.3 bar, 1.2 bar, 1.1 bar, or less. The pressure may be greater than atmospheric pressure (above atmospheric pressures). The pressure may be in a range from about 1.5 bar to about 25 bar. The pressure may be in a range from about 1 bar to about 70 bar. The pressure may be in a range from about 5 bar to about 25 bar. The pressure may be in a range from about 10 bar to about 20 bar. The pressure may be in a range from about 5 bar to about 15 bar. The pressure may be greater than or equal to about 2 bar. The pressure may be greater than or equal to about 5 bar. The pressure may be greater than or equal to about 10 bar. The feedstock or the process gas(es) may be provided to the reactor at a suitable pressure (e.g., at least about 0.01%, 0.05%, 0.1%, 0.5%, 1%, 2%, 5%, 10%, 15%, 20%, 25% or 50% above reactor pressure, which pressure may depend on mode of injection, such as, for example, a higher pressure through an injector than through an inlet port). The feedstock or a process gas may be provided to the reactor, for example, at its respective delivery or storage (e.g., cylinder or container) pressure. The feedstock or a process gas may or may not be (e.g., additionally) compressed before it is provided to the reactor. The incoming feedstock may be provided at a pressure in a range as defined by any two of the preceding pressure values. For example, the feedstock may be provided at a pressure in a range of about 30 to about 35 bar, and may be metered down to a pressure in a range of about 5 to about 15 bar. There may be a pressure drop across the reactor. For example, an inlet pressure of the reactor and an outlet pressure of the reactor may be different. The outlet pressure of the reactor may be a value selected from the preceding list that is less than an inlet pressure selected from the preceding list. For example, a reactor with an about 15 bar inlet pressure may have an about 14 bar outlet pressure. In another example, the inlet pressure may be about 4 bar and the outlet pressure may be about 2 bar. In another example, the inlet pressure may be about 35 bar and the outlet pressure may be about 30 bar. The pressure drop across the reactor can aid in the movement of gases or carbon particles through the reactor.

The one or more gases (e.g., the feedstock alone or in combination with at least one process gas) may be heated to or the feedstock may be subjected to (e.g., exposed to) a temperature of, for example, greater than or equal to about 1,000 degrees Celsius (° C.), 1,100° C., 1,200° C., 1,300° C., 1,400° C., 1,500° C., 1,600° C., 1,700° C., 1,800° C., 1,900° C., 2,000° C., 2050° C., 2,100° C., 2,150° C., 2,200° C., 2,250° C., 2,300° C., 2,350° C., 2,400° C., 2,450° C., 2,500° C., 2,550° C., 2,600° C., 2,650° C., 2,700° C., 2,750° C., 2,800° C., 2,850° C., 2,900° C., 2,950° C., 3,000° C., 3,050° C., 3,100° C., 3,150° C., 3,200° C., 3,250° C., 3,300° C., 3,350° C., 3,400° C., or 3,450° C. Alternatively, or in addition, the one or more gases (e.g., the feedstock alone or in combination with at least one process gas) may be heated to or the feedstock may be subjected to (e.g., exposed to) a temperature of, for example, less than or equal to about 3,500° C., 3,450° C., 3,400° C., 3,350° C., 3,300° C., 3,250° C., 3,200° C., 3,150° C., 3,100° C., 3,050° C., 3,000° C., 2,950° C., 2,900° C., 2,850° C., 2,800° C., 2,750° C., 2,700° C., 2,650° C., 2,600° C., 2,550° C., 2,500° C., 2,450° C., 2,400° C., 2,350° C., 2,300° C., 2,250° C., 2,200° C., 2,150° C., 2,100° C., 2050° C., 2,000° C., 1,900° C., 1,800° C., 1,700° C., 1,600° C., 1,500° C., 1,400° C., 1,300° C., 1,200° C. or 1,100° C. The one or more gases (e.g., the feedstock alone or in combination with at least one process gas) may be heated to such temperatures by a thermal generator (e.g., a plasma generator). The one or more gases (e.g., the feedstock alone or in combination with at least one process gas) gas may be electrically heated to such temperatures by the thermal generator (e.g., the thermal generator may be driven by electrical energy).

Thermal generators may operate at suitable powers. The power may be, for example, greater than or equal to about 0.5 kilowatt (kW), 1 kW, 1.5 kW, 2 kW, 5 kW, 10 kW, 25 kW, 50 kW, 75 kW, 100 kW, 150 kW, 200 kW, 250 kW, 300 kW, 350 kW, 400 kW, 450 kW, 500 kW, 550 kW, 600 kW, 650 kW, 700 kW, 750 kW, 800 kW, 850 kW, 900 kW, 950 kW, 1 megawatt (MW), 1.05 MW, 1.1 MW, 1.15 MW, 1.2 MW, 1.25 MW, 1.3 MW, 1.35 MW, 1.4 MW, 1.45 MW, 1.5 MW, 1.6 MW, 1.7 MW, 1.8 MW, 1.9 MW, 2 MW, 2.5 MW, 3 MW, 3.5 MW, 4 MW, 4.5 MW, 5 MW, 5.5 MW, 6 MW, 6.5 MW, 7 MW, 7.5 MW, 8 MW, 8.5 MW, 9 MW, 9.5 MW, 10 MW, 10.5 MW, 11 MW, 11.5 MW, 12 MW, 12.5 MW, 13 MW, 13.5 MW, 14 MW, 14.5 MW, 15 MW, 16 MW, 17 MW, 18 MW, 19 MW, 20 MW, 25 MW, 30 MW, 35 MW, 40 MW, 45 MW, 50 MW, 55 MW, 60 MW, 65 MW, 70 MW, 75 MW, 80 MW, 85 MW, 90 MW, 95 MW, or 100 MW. Alternatively, or in addition, the power may be, for example, less than or equal to about 100 MW, 95 MW, 90 MW, 85 MW, 80 MW, 75 MW, 70 MW, 65 MW, 60 MW, 55 MW, 50 MW, 45 MW, 40 MW, 35 MW, 30 MW, 25 MW, 20 MW, 19 MW, 18 MW, 17 MW, 16 MW, 15 MW, 14.5 MW, 14 MW, 13.5 MW, 13 MW, 12.5 MW, 12 MW, 11.5 MW, 11 MW, 10.5 MW, 10 MW, 9.5 MW, 9 MW, 8.5 MW, 8 MW, 7.5 MW, 7 MW, 6.5 MW, 6 MW, 5.5 MW, 5 MW, 4.5 MW, 4 MW, 3.5 MW, 3 MW, 2.5 MW, 2 MW, 1.9 MW, 1.8 MW, 1.7 MW, 1.6 MW, 1.5 MW, 1.45 MW, 1.4 MW, 1.35 MW, 1.3 MW, 1.25 MW, 1.2 MW, 1.15 MW, 1.1 MW, 1.05 MW, 1 MW, 950 kW, 900 kW, 850 kW, 800 kW, 750 kW, 700 kW, 650 kW, 600 kW, 550 kW, 500 kW, 450 kW, 400 kW, 350 kW, 300 kW, 250 kW, 200 kW, 150 kW, 100 kW, 75 kW, 50 kW, 25 kW, 10 kW, 5 kW, 2 kW, 1.5 kW, or 1 kW.

In some cases, the one or more electrodes may comprise one or more alternating current (AC) electrodes. AC electrodes may be electrodes configured to operate under AC conditions. For example, AC electrodes can be electronically coupled to an AC power supply and generate a plasma when AC current is flowed through the AC electrodes. In some cases, the one or more electrodes may comprise one or more direct current (DC) electrodes. DC electrodes may be configured to operate under DC conditions (e.g., when operatively coupled to a DC power supply). The reactor may be operated at a pressure (e.g., the reactor pressure) greater than or equal to at least about 0 bar, 0.5 bar, 1 bar, 1.1 bar, 1.2 bar, 1.3 bar, 1.4 bar, 1.5 bar, 1.6 bar, 1.7 bar, 1.8 bar, 1.9 bar, 2 bar, 2.1 bar, 2.2 bar, 2.3 bar, 2.4 bar, 2.5 bar, 2.6 bar, 2.7 bar, 2.8 bar, 2.9 bar, 3 bar, 3.1 bar, 3.2 bar, 3.3 bar, 3.4 bar, 3.5 bar, 3.6 bar, 3.7 bar, 3.8 bar, 3.9 bar, 4 bar, 4.5 bar, 5 bar, 6 bar, 7 bar, 8 bar, 9 bar, 10 bar, 11 bar, 12 bar, 13 bar, 14 bar, 15 bar, 16 bar, 17 bar, 18 bar, 19 bar, 20 bar, 21 bar, 22 bar, 23 bar, 24 bar, 25 bar, 26 bar, 27 bar, 28 bar, 29 bar, 30 bar, 35 bar, 40 bar, 45 bar, 50 bar, 55 bar, 60 bar, 65 bar, 70 bar, 75 bar, or more. The reactor may be operated at a pressure less than or equal to at most about 100 bar, 90 bar, 80 bar, 75 bar, 70 bar, 65 bar, 60 bar, 55 bar, 50 bar, 45 bar, 40 bar, 35 bar, 30 bar, 29 bar, 28 bar, 27 bar, 26 bar, 25 bar, 24 bar, 23 bar, 22 bar, 21 bar, 20 bar, 19 bar, 18 bar, 17 bar, 16 bar, 15 bar, 14 bar, 13 bar, 12 bar, 11 bar, 10 bar, 9 bar, 8 bar, 7 bar, 6 bar, 5 bar, 4 bar, 3.9 bar, 3.8 bar, 3.7 bar, 3.6 bar, 3.5 bar, 3.4 bar, 3.3 bar, 3.2 bar, 3.1 bar, 3 bar, 2.9 bar, 2.8 bar, 2.7 bar, 2.6 bar, 2.5 bar, 2.4 bar, 2.3 bar, 2.2 bar, 2.1 bar, 2 bar, 1.9 bar, 1.8 bar, 1.7 bar, 1.6 bar, 1.5 bar, 1.4 bar, 1.3 bar, 1.2 bar, 1.1 bar, or less. The reactor may be operated at a pressure in a range as defined by any two of the preceding values. For example, the reactor may be operated at a pressure in a range of about 1.1 bar to about 4 bar.

In some cases, the process may produce hydrogen. For example, in the production of the carbon particles, hydrogen gas may be produced as well. The hydrogen may be discarded (e.g., disposed of as waste from the process). The hydrogen may be collected (e.g., as an additional product of the process). The hydrogen and the carbon particles can be produced in a once-through, single stage process. For example, the hydrogen and the carbon particles can be produced at a same time (e.g., the process operations that generate the carbon particles can also generate the hydrogen). In this example, the hydrogen and the carbon particles can be produced in a single operation of the reactor (e.g., in a same hydrocarbon decomposition operation). The single stage process may provide increased reaction efficiency (e.g., the efficiency of heat transfer from the plasma to the feedstock). Further, the single stage process can provide for higher plasma temperatures. For example, the plasma in a single stage process can be at temperatures in a range of about 3500° C. to about 4000° C. The single stage process may have a heat gradient between the center of the reactor and the walls of the reactor. The heat gradient between the center of the reactor and the walls of the reactor may be less in a single stage process than in a multiple stage process. For example, a heat gradient in a single stage process may be from a central temperature of 3500° C. to a wall temperature of about 18000° C., while a two stage process may have a central temperature of about 3500° C. and a wall temperature of about 2200° C. to about 2400° C. The single stage process may enable cost savings due to the types of materials of construction and maintenance possible. For example, the lower temperatures near the walls of the reactor may enable lower cost materials to be used for the construction of the reactor and may reduce the thermal wear on the wall of the reactor. The single stage reactor may have a dense (e.g., optically dense) field of carbon particles at or in close vicinity (e.g., as described elsewhere herein) of the electric arc. Such a dense field can provide increased heat transfer into the carbon particles and decreased heat transfer to the walls of the reactor.

In some cases, the hydrogen and the carbon particles can be produced in a multiple stage or “multi-stage” (e.g., two stage, three stage, etc.) process. For example, a two stage process may comprise a first injection of the hydrocarbon and a second injection of the hydrocarbon. The use of a multi-stage process can reduce fouling in the reactor or on the electrodes by lowering the amount of hydrocarbon in a given area of the reactor. Multiple stages also can enable additional process operations to occur between the stages. For example, a water injection can be performed to remove fouling from the reactor without having to shut down the reactor or disable the plasma. Multiple stages also can provide increased mixing of the feedstocks into the plasma gas due to the increased velocity and momentum of the plasma gas.

The plasma reactors of the present disclosure may be operated at a temperature of at least about 1000, 1100, 1200, 1300, 1400, 1500, 1600, 1700, 1800, 1900, 2000, 2100, 2200, 2300, 2400, 2500, 2600, 2700, 2800, 2900, 3000, 3100, 3200, 3300, 3400, 3500, 3600, 3700, 3800, 3900, 4000, 4100, 4200, 4300, 4400, 4500, or more degrees Celsius (° C.). The plasma reactors of the present disclosure may be operated at a temperature of at most about 4500, 4400, 4300, 4200, 4100, 4000, 3900, 3800, 3700, 3600, 3500, 3400, 3300, 3200, 3100, 3000, 2900, 2800, 2700, 2600, 2500, 2400, 2300, 2200, 2100, 2000, 1900, 1800, 1700, 1600, 1500, 1400, 1300, 1200, 1100, 1000, or less degrees Celsius (° C.). The plasma reactors of the present disclosure may be operated at a temperature in a range as defined by any two of the preceding values. For example, a plasma reactor can be operated at a temperature from about 3500° C. to about 4000° C. The temperature gradient between the center of a reactor of the present disclosure and a wall of the reactor may be a difference of at least about 50, 100, 200, 300, 400, 500, 600, 700, 800, 900, 1000, 1100, 1200, 1300, 1400, 1500, 1600, 1700, 1800, 1900, 2000, or more degrees Celsius. For example, the difference in temperature between the center of the reactor and a wall of the reactor may be at least about 1700 degrees Celsius. The temperature gradient between the center of the reactor and a wall of the reactor may be a difference of at most about 2000, 1900, 1800, 1700, 1600, 1500, 1400, 1300, 1200, 1100, 1000, 900, 800, 700, 600, 500, 400, 300, 200, 100, 50, or fewer degrees Celsius. The temperature gradient between the center of the reactor and a wall of the reactor may be defined by a range of any two of the preceding values. The magnitude of the gradient may be related to the type of reactor system used. For example, a single stage reactor may provide a larger temperature gradient than a multi-stage reactor.

In some cases, the systems and methods described herein may produce about 1 ton per hour of hydrogen. The produced hydrogen may be purified to a given purity of, for example, about 90%, 95%, 99%, 99.5%, or 99.9%. In some cases, hydrogen is produced at a rate in a range of about 0.1 tons per hour to about 10 tons per hour. In some cases, hydrogen is produced at a rate in a range of about 0.1 tons per hour to about 0.5 tons per hour, about 0.1 tons per hour to about 1 ton per hour, about 0.1 tons per hour to about 5 tons per hour, about 0.1 tons per hour to about 10 tons per hour, about 0.5 tons per hour to about 1 ton per hour, about 0.5 tons per hour to about 5 tons per hour, about 0.5 tons per hour to about 10 tons per hour, about 1 ton per hour to about 5 tons per hour, about 1 ton per hour to about 10 tons per hour, or about 5 tons per hour to about 10 tons per hour. In some cases, hydrogen is produced at a rate of about 0.1 tons per hour, about 0.5 tons per hour, about 1 ton per hour, about 5 tons per hour, or about 10 tons per hour. In some cases, hydrogen is produced at a rate of at least about 0.1 tons per hour, about 0.5 tons per hour, about 1 ton per hour, or about 5 tons per hour. In some cases, hydrogen is produced at a rate of at most about 0.5 tons per hour, about 1 ton per hour, about 5 tons per hour, or about 10 tons per hour.

Solid carbonaceous materials may be separated from gaseous components. Separation units or hydrogen/tail gas removal units may include, but are not limited to, pressure swing adsorption devices, cryogenic separation devices, molecular sieves, or the like, or any combination thereof. The pressure swing adsorption (PSA) device may be configured to separate or purify components from a gas stream (e.g., components from a gas stream generated by a reactor as described elsewhere herein). The PSA device may comprise use of adsorption and the characteristics of the different components of a gas mixture (e.g., molecular size, dipole moment, etc.) to selectively pass through components of the mixture. For example, a PSA device can be used to separate hydrogen out of a reactor gas mixture. In this example, the PSA device can use the smaller size of a hydrogen gas molecule to separate the hydrogen from larger gas species by passing the gas mixture over a porous bed (e.g., a bed of porous zeolite) that can act as a molecular sieve. In this example, the hydrogen can pass through the sieve while larger species in the gas mixture are filtered out by becoming trapped in the sieve. In this example, the sieve(s) can saturate with the larger gases, at which point the bed can be removed and regenerated through removal of the larger gas species. A plurality of PSA devices can be used in parallel or in series. For example, a plurality of PSA devices can be set in parallel to permit continuous processing of gases while a subset of the PSA devices is being regenerated. A PSA device can be operated at a pressure of at least about 1, 5, 10, 11, 12, 13, 14, 15, 16, 17, 18, 19, 20, 21, 22, 23, 24, 25, 26, 27, 28, 29, 30, or more bar gauge (barg). A PSA device can be operated at a pressure of at most about 30, 29, 28, 27, 26, 25, 24, 23, 22, 21, 20, 19, 18, 17, 16, 15, 14, 13, 12, 11, 10, 5, or fewer bar gauge (barg). A PSA device can be operated at a pressure in a range as defined by any two of the preceding values. For example, a PSA device can be operated at a pressure between about 13 and about 24 barg. A PSA device may be operated at a gas inlet temperature of at least about −50, −45, −40, −35, −30, −25, −20, −15, −10, −5, 0, 5, 10, 15, 20, 25, 30, 35, 40, 45, 50, 55, 60, 65, 70, or more degrees Celsius. A PSA device may be operated at a gas inlet temperature of at most about 70, 65, 60, 55, 50, 45, 40, 35, 30, 25, 20, 15, 10, 5, 0, −5, −10, −15, −20, −25, −30, −45, −50, or less degrees Celsius. For example, the PSA may operate at a temperature above where a component of the gas mixture condenses.

A cryogenic separation device may be configured to separate components (e.g., different gases of a gas mixture) through utilization of cryogenic (e.g., sub-ambient) temperatures. For example, a cryogenic separation device can be configured to cool a mixture until all components of the mixture have condensed, and subsequently use increases in temperature or pressure to remove (e.g., boil off) components in order to separate them. Cryogenic separation may provide high purities of the components of the gas mixture (e.g., hydrogen).

Once separated from a gas mixture, hydrogen from the reactor can be further purified. In some cases, the hydrogen is of sufficient purity upon removal from the gas mixture (e.g., no further purification may be performed). In some cases, the hydrogen is purified by a PSA device, a cryogenic separation device, a molecular sieve, or the like, or any combination thereof. In some cases, the hydrogen may be pressurized upon removal from the gas mixture. For example, the hydrogen may be pressurized prior to being fed into a purification apparatus. After purification, the hydrogen can be of a purity of at least about 50, 60, 70, 80, 85, 90, 91, 92, 93, 94, 95, 96, 97, 98, 99, 99.9, 99.99, 99.999, 99.9999, 99.99999, or more percent (e.g., percent by mole, mass, or volume). After purification, the hydrogen can be at a purity of at most about 99.99999, 99.9999, 99.999, 99.99, 99.9, 99, 98, 97, 96, 95, 94, 93, 92, 91, 90, 85, 80, 70, 60, 50, or less percent (e.g., percent by mole, mass, or volume). The gas removed from the hydrogen during purification may comprise hydrocarbons (e.g., methane, ethane, ethylene, acetylene, propene, benzene, toluene, naphthalene, anthracene, etc.), hydrogen, nitrogen, hydrogen cyanide, carbon monoxide, noble gases (e.g., argon, neon, krypton, etc.), or the like, or any combination thereof. The gas removed from the hydrogen may comprise at least about 1, 2, 3, 4, 5, 6, 7, 8, 9, 10, 11, 12, 13, 14, 15, 16, 17, 18, 19, 20, 21, 22, 23, 24, 25, or more percent by mole of the gas mixture. The gas removed from the hydrogen may comprise at most about 25, 24, 23, 22, 21, 20, 19, 18, 17, 16, 15, 14, 13, 12, 11, 10, 9, 8, 7, 6, 5, 4, 3, 2, 1, or less percent by mole of the gas mixture.

The system or process may further comprise a high pressure degassing apparatus (referred to as “degassing apparatus” or “degasser” herein). Carbon particles as described elsewhere herein (e.g., carbon black, etc.) generated by the processes described elsewhere herein may be directed into the top of the degasser (FIG. 1 item 150). The carbon particles may initially contact a filter (FIG. 1 item 140) prior to the degasser, and fall from the filter into the top of the degasser. The carbon particles may contact a rotary valve. The rotary valve may be configured to meter the carbon particles by dropping the carbon particles through open airlock valves into the degasser. The presence of the rotary valve may prevent too many carbon particles from entering the degasser at once. The rotary valve also may provide an amount of backflow protection against gases from the degasser flowing back. The carbon particles may collect in the degasser until a predetermined amount of carbon particles has been reached. Subsequently, the rotary valve and airlock valves can be closed, and a vent valve can be opened. The vent valve opening can relieve the gas at pressure (e.g., above atmospheric pressures) in the degasser (e.g., if the carbon particles are introduced to the vessel under pressure) and place the degasser at atmospheric pressures. The vent valve can then be closed, and an inert purge valve can be opened to permit flow of inert gas (e.g., inert gas as described elsewhere herein). The inert gas may be configured to displace or dilute gases associated (e.g., adsorbed) with the carbon particles. For example, combustible or explosive gases (e.g., hydrogen, hydrocarbons, etc.) can be adsorbed to the surface of the carbon particles, and the inert gas can displace the combustible or explosive gases. After the introduction of the inert gas, the purge valve can be closed, and the vent valve can be opened to vent the mixture of the inert gas and the gases associated with the carbon particles. The purging with inert gas can be repeated until the carbon particles are considered inert (e.g., the gases within the carbon particles are present at a safe level). The carbon particles can then be removed from the degassing apparatus via airlock valves. For example, the airlock valves may be opened, and the carbon particles may fall out of the degasser via gravity. The airlock valves can then be closed, and the process repeated for another batch of carbon particles.

Use of a high pressure degassing apparatus (degasser) may enable collection of gases associated with the carbon particles (e.g., hydrogen) at elevated pressures (e.g., pressures above atmospheric pressures). For example, the hydrogen adsorbed to the pores of the carbon particles can be collected at the same elevated pressure as the reactor system operating pressure. Recovering the gases at elevated pressures can enable use of the gases in elevated pressure systems (e.g., high pressure chemical synthesis, combustion, fuel cells, etc.) without use of a secondary pressurizing apparatus. Thus, the gases can be more easily used in downstream processes due to the elevated pressure of the gases. This can reduce engineering requirements and improve the functioning of systems as compared to if the gases were recovered at lower pressures.

### Compositions

The systems and methods described herein may produce a carbon product with a greater carbon-14 to carbon-12 ratio than an identical system or method that uses a fossil fuel hydrocarbon feedstock. For example, a carbon product produced using a fossil fuel feedstock can have a carbon-14 to carbon-12 ratio of greater than about 3*10⁻¹³. The carbon product as described herein can have a carbon-14 to carbon-12 ratio greater than about 3*10⁻¹³. Carbon products produced by the systems and methods described herein may have over 10% more carbon-14 than carbon products produced from a fossil fuel hydrocarbon feedstock. Carbon products produced by the systems and methods described herein may have over 5% more carbon-14 than carbon products produced from a fossil fuel hydrocarbon feedstock.

The carbonaceous material produced may comprise carbon particles. The carbon particles may comprise carbon black. Examples of carbon particles include, but are not limited to, carbon black, coke, needle coke, graphite, large ring polycyclic aromatic hydrocarbons, activated carbon, or the like, or any combination thereof. The carbon particles may be produced by the process at a yield greater than a yield of carbon particles formed by the reactor when operated at a lower pressure than the pressure of the process (e.g., about 1 bar, less than about 1.5 bar, etc.). The carbon particles may be produced at a yield of at least about 5, 10, 15, 20, 25, 30, 35, 40, 45, 50, 55, 60, 65, 70, 75, 80, 81, 82, 83, 84, 85, 86, 87, 88, 89, 90, 91, 92, 93, 94, 95, 96, 97, 98, 99, 99.9, or more percent. The carbon particles may be produced at a yield of at most about 99.9, 99, 98, 97, 96, 95, 94, 93, 92, 91, 90, 89, 88, 87, 86, 85, 84, 83, 82, 81, 80, 75, 70, 65, 60, 55, 50, 45, 40, 35, 30, 25, 20, 15, 10, 5, or less percent. The yield of the carbon particles may be a value in a range as defined by any two of the preceding values. For example, the yield of the carbon particles may be from about 90 to about 99 percent. The yield of the carbon particles in the process may be greater than a yield of carbon particles formed in a different reactor of a same size as the reactor of the process when the different reactor is operated at a pressure less than that of the reactor of the process.

Carbonaceous material (e.g., carbon particles) may be generated at a yield (e.g., yield based upon feedstock conversion rate, based on total hydrocarbon provided, on a mass percent carbon basis, or as measured by moles of product carbon vs. moles of reactant carbon) of, for example, greater than or equal to about 1%, 5%, 10%, 25%, 50%, 55%, 60%, 65%, 70%, 75%, 80%, 85%, 90%, 91%, 92%, 93%, 94%, 95%, 96%, 97%, 98%, 99%, 99.5% or 99.9%.

Alternatively, or in addition, the carbonaceous material (e.g., carbon particles) may be generated at a yield (e.g., yield based upon feedstock conversion rate, based on total hydrocarbon provided, on a mass percent carbon basis, or as measured by moles of product carbon vs. moles of reactant carbon) of, for example, less than or equal to about 100%, 99.9%, 99.5%, 99%, 98%, 97%, 96%, 95%, 94%, 93%, 92%, 91%, 90%, 85%, 80%, 75%, 70%, 65%, 60%, 55%, 50%, 25% or 5%.

The carbon particles may comprise larger carbon particles. The larger carbon particles may have a volume equivalent sphere diameter of greater than about 0.5, 0.6, 0.7, 0.75, 0.8, 0.9, 1, 1.1, 1.2, 1.25, 1.3, 1.4, 1.5, 1.6, 1.7, 1.75, 1.8, 1.9, 2, 2.1, 2.2, 2.25, 2.3, 2.4, 2.5, 2.6, 2.7, 2.75, 2.8, 2.9, 3, 4, 5, or more micrometers (μm) and, for example, a nitrogen surface area (N2SA) of less than about 50, 40, 30, 20, 15, 10, 5, or less square meters per gram (m²/g). For example, the larger carbon particles may have a volume equivalent sphere diameter of at least about 2 micrometers and an N2SA of less than about 15 square meters per gram. The larger carbon particles may be caught in a catchpot. The carbon particles may comprise carbon particles with a volume equivalent sphere diameter of less than about 5, 4, 3, 2.9, 2.8, 2.75, 2.7, 2.6, 2.5, 2.4, 2.3, 2.25, 2.2, 2.1, 2, 1.9, 1.8, 1.75, 1.7, 1.6, 1.5, 1.4, 1.3, 1.25, 1.2, 1.1, 1, 0.9, 0.8, 0.75, 0.7, 0.6 0.5, 0.4, 0.3, 0.25, 0.2, 0.1, or less micrometers (μm). For example, the carbon particles may have a volume equivalent sphere diameter of less than about 2 micrometers. The carbon particles may have a ratio of larger carbon particles (e.g., with a volume equivalent sphere diameter of greater than about 2 micrometers) to smaller carbon particles (e.g., with a volume equivalent sphere diameter of less than or equal to about 2 micrometers) of about 0/100, 5/95, 10/90, 15/85, 20/80, 25/75, 30/70, 35/65, 40/60, 45/55, 50/50, 55/45, 60/40, 65/35, 70/30, 75/25, 80/20, 85/15, 90/10, or 100/0. The systems and methods described herein may be configured to be tuned to generate a predetermined ratio of larger carbon particles to carbon particles with a volume equivalent sphere diameter of less than about 2 micrometers. The volume equivalent sphere diameter may be measured by centrifugal particle sedimometry. Additional information can be found in the book “Principles of Colloid and Surface Chemistry,” Hiemenz, Rajagopalan, Third Edition, pp. 70-78, which is incorporated by reference herein in its entirety.

A surface area of the carbon particles may be modified by altering an operating pressure of the carbon particle generating reactor. For example, a reactor process with a lower pressure may generate carbon particles with a smaller surface area. For example, carbon particles generated by a reactor operated at a pressure of 1.5 bar may have a smaller surface area than carbon particles formed in the same reactor operated at a pressure of 2.5 bar. In another example, the carbon particles generated by the reactor operated at a pressure of 3 bar may have a smaller surface area than carbon particles formed in the same reactor operated at a pressure of 5 bar.

The surface area of the carbon particles may be increased using one or more additives. The one or more additives may be added to the hydrocarbon before, during, or after the hydrocarbon is injected into the reactor. The one or more additives may be injected into the reactor prior to the plasma. Examples of additives include, but are not limited to, hydrocarbons (e.g., hydrocarbons described elsewhere herein, hydrocarbon gases), silicon-containing compounds (e.g., siloxanes, silanes, etc.), aromatic additives (e.g., benzene, xylenes, polycyclic aromatic hydrocarbons, etc.), or the like, or any combination thereof. The reactor may be an oxygen-free environment. The oxygen-free environment may be an unbound oxygen-free environment. For example, the reactor may be substantially free of unbound oxygen (e.g., elemental oxygen) but may comprise bound oxygen (e.g., as a part of ethanol, carbon dioxide, etc.). The reactor may comprise less than at most about 20, 15, 14, 13, 12, 11, 10, 9, 8, 7, 6, 5, 4, 3, 2, 1, 0.5, 0.1, 0.05, 0.01, 0.005, 0.001, 0.0005, 0.0001, or less percent molecular oxygen by volume or mole.

In some cases, the carbon particle may comprise at least one silicon core decorated with carbon. For example, in contacting the carbonaceous material and a silicon-containing additive, the silicon-containing additive can react faster than the carbonaceous material, which can lead to the formation of a silicon core. In this example, the carbonaceous material can then react and form carbon decoration around the silicon core. The silicon core may comprise at least silicon, silicon carbide, silicon oxycarbide, silicon dioxide, or the like, or any combination thereof. The process may comprise contacting the carbonaceous material with the silicon-containing additive to generate a plurality of carbon particles. For example, a plurality of carbon particles may be generated in a continuous flow scheme where the carbonaceous material and the silicon-containing additive are added to a flow reactor. The plurality of carbon particles can be generated in a batch process. For example, a predetermined amount of carbonaceous material and silicon-containing additive can be added to a batch reactor, allowed to react, and the resultant carbon particles can be recovered from the batch reactor.

The silicon core may comprise at least about 40, 45, 50, 55, 60, 65, 70, 75, 80, 85, 90, 95, 96, 97, 98, 99, or more percent silicon. The silicon core may comprise at most about 99, 98, 97, 96, 95, 90, 85, 80, 75, 70, 65, 60, 55, 50, 45, 40, or less percent silicon. The silicon core may comprise an amount of silicon in a range as defined by any two of the preceding values. The silicon core may be at least about 1, 5, 10, 20, 30, 40, 50, 60, 70, 80, 90, 100, 200, 300, 400, 500, or more nanometers (nm) in diameter. The silicon core may be at most about 500, 400, 300, 200, 100, 90, 80, 70, 60, 50, 40, 30, 20, 10, 5, 1, or fewer nanometers (nm) in diameter. A plurality of silicon cores may have diameters in a range as defined by any two of the preceding values. The silicon core may comprise pure silicon, silicon carbide, silicon oxycarbides, silicon oxides, silicon nitrides, or the like, or any combination thereof. The silicon core may provide a lower energy surface for growth of carbonaceous material. The method may comprise generating a plurality of nucleates each comprising a silicon core. For example, the reactor can be configured to generate a plurality of nucleates to scale up a production of carbon particles. The core may be located within the carbon particle, on a surface of the carbon particle, or the like. The core may be located separate from the carbon particle.

The systems and methods described herein may be configured to or may comprise generating hydrogen. In some cases, the systems and methods described herein produce 1 ton per hour of hydrogen. The produced hydrogen may be purified to a given purity of, for example, 90%, 95%, 99%, 99.5%, or 99.9%. In some cases, hydrogen is produced at a rate in a range of about 0.1 tons per hour to about 10 tons per hour. In some cases, hydrogen is produced at a rate in a range of about 0.1 tons per hour to about 0.5 tons per hour, about 0.1 tons per hour to about 1 ton per hour, about 0.1 tons per hour to about 5 tons per hour, about 0.1 tons per hour to about 10 tons per hour, about 0.5 tons per hour to about 1 ton per hour, about 0.5 tons per hour to about 5 tons per hour, about 0.5 tons per hour to about 10 tons per hour, about 1 ton per hour to about 5 tons per hour, about 1 ton per hour to about 10 tons per hour, or about 5 tons per hour to about 10 tons per hour. In some cases, hydrogen is produced at a rate of about 0.1 tons per hour, about 0.5 tons per hour, about 1 ton per hour, about 5 tons per hour, or about 10 tons per hour. In some cases, hydrogen is produced at a rate of at least about 0.1 tons per hour, about 0.5 tons per hour, about 1 ton per hour, or about 5 tons per hour. In some cases, hydrogen is produced at a rate of at most about 0.5 tons per hour, about 1 ton per hour, about 5 tons per hour, or about 10 tons per hour.

Systems and methods of the present disclosure may be combined with or modified by other systems and/or methods (with appropriate modification(s)), such as, for example, chemical processing and heating methods, chemical processing systems, reactors and plasma torches described in U.S. Pat. Pub. No. US 2015/0210856 and Int. Pat. Pub. No. WO 2015/116807 (“SYSTEM FOR HIGH TEMPERATURE CHEMICAL PROCESSING”), U.S. Pat. Pub. No.

US 2015/0211378 (“INTEGRATION OF PLASMA AND HYDROGEN PROCESS WITH COMBINED CYCLE POWER PLANT, SIMPLE CYCLE POWER PLANT AND STEAM REFORMERS”), Int. Pat. Pub. No. WO 2015/116797 (“INTEGRATION OF PLASMA AND HYDROGEN PROCESS WITH COMBINED CYCLE POWER PLANT AND STEAM REFORMERS”), U.S. Pat. Pub. No. US 2015/0210857 and Int. Pat. Pub. No. WO 2015/116798 (“USE OF FEEDSTOCK IN CARBON BLACK PLASMA PROCESS”), U.S. Pat. Pub. No. US 2015/0210858 and Int. Pat. Pub. No. WO 2015/116800 (“PLASMA GAS THROAT ASSEMBLY AND METHOD”), U.S. Pat. Pub. No. US 2015/0218383 and Int. Pat. Pub. No. WO 2015/116811 (“PLASMA REACTOR”), U.S. Pat. Pub. No. US 2015/0223314 and Int. Pat. Pub. No. WO 2015/116943 (“PLASMA TORCH DESIGN”), Int. Pat. Pub. No. WO 2016/126598 (“CARBON BLACK COMBUSTABLE GAS SEPARATION”), Int. Pat. Pub. No. WO 2016/126599 (“CARBON BLACK GENERATING SYSTEM”), Int. Pat. Pub. No. WO 2016/126600 (“REGENERATIVE COOLING METHOD AND APPARATUS”), U.S. Pat. Pub. No. US 2017/0034898 and Int. Pat. Pub. No. WO 2017/019683 (“DC PLASMA TORCH ELECTRICAL POWER DESIGN METHOD AND APPARATUS”), U.S. Pat. Pub. No. US 2017/0037253 and Int. Pat. Pub. No. WO 2017/027385 (“METHOD OF MAKING CARBON BLACK”), U.S. Pat. Pub. No. US 2017/0058128 and Int. Pat. Pub. No. WO 2017/034980 (“HIGH TEMPERATURE HEAT INTEGRATION METHOD OF MAKING CARBON BLACK”), U.S. Pat. Pub. No. US 2017/0066923 and Int. Pat. Pub. No. WO 2017/044594 (“CIRCULAR FEW LAYER GRAPHENE”), U.S. Pat. Pub. No. US 2017/0073522 and Int. Pat. Pub. No. WO 2017/048621 (“CARBON BLACK FROM NATURAL GAS”), Int. Pat. Pub. No. WO 2017/190045 (“SECONDARY HEAT ADDITION TO PARTICLE PRODUCTION PROCESS AND APPARATUS”), Int. Pat. Pub. No. WO 2017/190015 (“TORCH STINGER METHOD AND APPARATUS”), Int. Pat. Pub. No. WO 2018/165483 (“SYSTEMS AND METHODS OF MAKING CARBON PARTICLES WITH THERMAL TRANSFER GAS”), Int. Pat. Pub. No. WO 2018/195460 (“PARTICLE SYSTEMS AND METHODS”), Int. Pat. Pub. No. WO 2019/046322 (“PARTICLE SYSTEMS AND METHODS”), Int. Pat. Pub. No. WO 2019/046320 (“SYSTEMS AND METHODS FOR PARTICLE GENERATION”), Int. Pat. Pub. No. WO 2019/046324 (“PARTICLE SYSTEMS AND METHODS”), Int. Pat. Pub. No. WO 2019/084200 (“PARTICLE SYSTEMS AND METHODS”), Int. Pat. Pub. No. WO 2019/195461 (“SYSTEMS AND METHODS FOR PROCESSING”), Int. Pat. Pub. No. WO 2022/076306 (“SYSTEMS AND METHODS FOR PROCESSING”), Int. Pat. Pub. No. WO 2023/059520 (“SYSTEMS AND METHODS FOR ELECTRIC PROCESSING”), Int. Pat. Pub. No. WO 2023/137120 (“METHODS AND SYSTEMS FOR USING SILICON-CONTAINING ADDITIVES TO PRODUCE CARBON PARTICLES”), and Int. Pat. App. No. PCT/US2023/0241148 (“RECYCLED FEEDSTOCKS FOR CARBON AND HYDROGEN PRODUCTION”), each of which is incorporated herein by reference in its entirety.

### Computer Systems

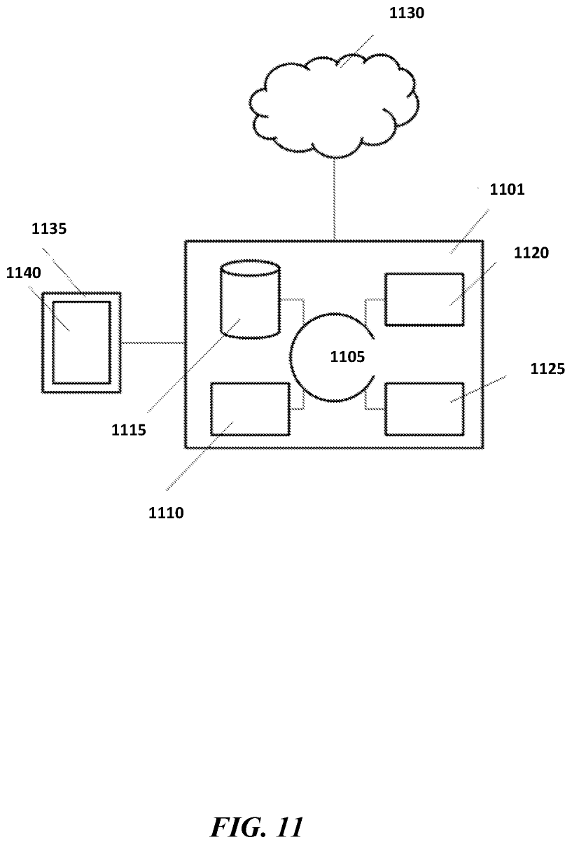

The present disclosure provides computer systems that are programmed to implement methods of the disclosure. FIG. 11 shows a computer system 1101 that is programmed or otherwise configured to implement the methods or control the systems of the present disclosure. The computer system 1101 can regulate various aspects of the present disclosure, such as, for example, a reactor configured to react a feedstock (e.g., a hydrocarbon feedstock) with reduced reactor fouling. The computer system 1101 can be an electronic device of a user or a computer system that is remotely located with respect to the electronic device. The electronic device can be a mobile electronic device.

The computer system 1101 includes a central processing unit (CPU, also “processor” and “computer processor” herein) 1105, which can be a single core or multi core processor, or a plurality of processors for parallel processing. The computer system 1101 also may include memory or a memory location 1110 (e.g., random-access memory, read-only memory, flash memory), an electronic storage unit 1115 (e.g., hard disk), a communication interface 1120 (e.g., network adapter) for communicating with one or more other systems, and peripheral devices 1125, such as cache, other memory, data storage or electronic display adapters. The memory 1110, storage unit 1115, interface 1120, and peripheral devices 1125 are in communication with the CPU 1105 through a communication bus (solid lines), such as a motherboard. The storage unit 1115 can be a data storage unit (or data repository) for storing data. The computer system 1101 can be operatively coupled to a computer network (“network”) 1130 with the aid of the communication interface 1120. The network 1130 can be the Internet, an internet or extranet, or an intranet or extranet that is in communication with the Internet. The network 1130 in some cases is a telecommunication or data network. The network 1130 may include one or more computer servers, which can enable distributed computing, such as cloud computing. The network 1130, in some cases with the aid of the computer system 1101, can implement a peer-to-peer network, which may enable devices coupled to the computer system 1101 to behave as a client or a server.

The CPU 1105 can execute a sequence of machine-readable instructions, which can be embodied in a program or software. The instructions may be stored in a memory location, such as the memory 1110. The instructions can be directed to the CPU 1105, which can subsequently program or otherwise configure the CPU 1105 to implement methods of the present disclosure. Examples of operations performed by the CPU 1105 can include fetch, decode, execute, and writeback.

The CPU 1105 can be part of a circuit, such as an integrated circuit. One or more other components of the system 1101 can be included in the circuit. In some cases, the circuit is an application specific integrated circuit (ASIC).

The storage unit 1115 can store files, such as drivers, libraries and saved programs. The storage unit 1115 can store user data, e.g., user preferences and user programs. The computer system 1101 in some cases may include one or more additional data storage units that are external to the computer system 1101, such as located on a remote server that is in communication with the computer system 1101 through an intranet or the Internet.

The computer system 1101 can communicate with one or more remote computer systems through the network 1130. For instance, the computer system 1101 can communicate with a remote computer system of a user. Examples of remote computer systems include personal computers (e.g., portable PC), slate or tablet PC's (e.g., Apple® iPad, Samsung® Galaxy Tab), telephones, Smart phones (e.g., Apple® iPhone, Android-enabled device, Blackberry®), or personal digital assistants. The user can access the computer system 1101 via the network 1130.

Methods as described herein may be implemented by way of machine (e.g., computer processor) executable code stored on an electronic storage location of the computer system 1101, such as, for example, on the memory 1110 or electronic storage unit 1115. The machine executable or machine readable code can be provided in the form of software. During use, the code can be executed by the processor 1105. In some cases, the code can be retrieved from the storage unit 1115 and stored on the memory 1110 for ready access by the processor 1105. In some situations, the electronic storage unit 1115 may be precluded, and machine-executable instructions may be stored on memory 1110.

The code can be pre-compiled and configured for use with a machine having a processer adapted to execute the code, or can be compiled during runtime. The code can be supplied in a programming language that can be selected to enable the code to execute in a pre-compiled or as-compiled fashion.

Aspects of the systems and methods provided herein, such as the computer system 1101, can be embodied in programming. Various aspects of the technology may be thought of as “products” or “articles of manufacture” typically in the form of machine (or processor) executable code or associated data that is carried on or embodied in a type of machine readable medium. Machine-executable code can be stored on an electronic storage unit, such as memory (e.g., read-only memory, random-access memory, flash memory) or a hard disk. “Storage” type media can include any or all of the tangible memory of the computers, processors or the like, or associated modules thereof, such as various semiconductor memories, tape drives, disk drives and the like, which may provide non-transitory storage at any time for the software programming. All or portions of the software may at times be communicated through the Internet or various other telecommunication networks. Such communications, for example, may enable loading of the software from one computer or processor into another, for example, from a management server or host computer into the computer platform of an application server. Thus, another type of media that may bear the software elements includes optical, electrical and electromagnetic waves, such as used across physical interfaces between local devices, through wired and optical landline networks and over various wireless or air-links. The physical elements that carry such waves, such as wired or wireless links, optical links or the like, also may be considered as media bearing the software. As used herein, unless restricted to non-transitory, tangible “storage” media, terms such as computer or machine “readable medium” refer to any medium that participates in providing instructions to a processor for execution.

Hence, a machine readable medium, such as computer-executable code, may take many forms, including but not limited to, a tangible storage medium, a carrier wave medium or physical transmission medium. Non-volatile storage media include, for example, optical or magnetic disks, such as any of the storage devices in any computer(s) or the like, such as may be used to implement databases, etc. Volatile storage media may include dynamic memory, such as main memory of such a computer platform. Tangible transmission media may include coaxial cables, copper wire and fiber optics, including the wires that comprise a bus within a computer system. Carrier-wave transmission media may take the form of electric or electromagnetic signals, or acoustic or light waves such as those generated during radio frequency (RF) and infrared (IR) data communications. Common forms of computer-readable media therefore include, for example: a floppy disk, a flexible disk, hard disk, magnetic tape, any other magnetic medium, a CD-ROM, DVD or DVD-ROM, any other optical medium, punch cards paper tape, any other physical storage medium with patterns of holes, a RAM, a ROM, a PROM and EPROM, a FLASH-EPROM, any other memory chip or cartridge, a carrier wave transporting data or instructions, cables or links transporting such a carrier wave, or any other medium from which a computer may read programming code or data. Many of these forms of computer readable media may be involved in carrying one or more sequences of one or more instructions to a processor for execution.

The computer system 1101 can include or be in communication with an electronic display 1135 that comprises a user interface (UI) 1140 for providing, for example, an interface for controlling a reactor. Examples of UI's include, without limitation, a graphical user interface (GUI) and a web-based user interface.

Methods and systems of the present disclosure can be implemented by way of one or more algorithms. An algorithm can be implemented by way of software upon execution by the central processing unit 1105. The algorithm can, for example, implement production of different carbon particles based on user interface.

### Example: Reactor Fouling

In an example, a reactor is operated for a time period of months in a stable mechanical configuration. The reactor may comprise two chambers, a plasma generating section and a carbon particle generating section, separated by a throat section. The reactor may further include a flow straightening device (also referred to herein as a “flow straightener”) of the present disclosure disposed downstream of the throat section. In this example, the flow straightener utilized was of a similar obstacle configuration to those shown in FIGS. 4 and 7A.

Table 1A shows example run data, including reactor configurations and injection hours per run, for a first set of example runs (runs 1-10) performed without a flow straightener. Table 1B shows run data, including reactor configurations and injection hours per run, for a second set of example runs (runs 11-21) performed with a flow straightening device of the present disclosure. Table 2A shows example reactor fouling data for the first set of example runs (runs 1-10) performed without the flow straightener. Table 2B shows example reactor fouling data for the second set of example runs (runs 11-21) performed with a flow straightening device of the present disclosure.

In the example runs without a flow straightener, in which the reactor bulk flow is estimated to have a Swirl Number between about 1.5 and about 4, the average injection duration prior to shut down is about forty hours. In the example runs that include a flow straightener, in which the reactor bulk flow is estimated to have a Swirl Number of less than one, the average injection duration is greater than eighty hours. As shown in Tables 1A-1B and Table 2A-2B, different injector configurations may yield different fouling results. The “TB” injector designation may represent a “toothbrush” type injector that is inserted radially into the bulk flow of the plasma gas with a nozzle that directs the feedstock in axial alignment with the co-flow plasma gas (e.g., bulk fluid flow). The “RI” injector designation may represent a “radial injector” configured to inject feedstock into the bulk flow of the plasma gas perpendicular to the axis of the bulk flow of the plasma gas to promote mixing of the two fluids.

TABLE 1A
Base Case: Example reactor configurations
and injection hours per run.

| | | | | Torch | Injection |
|---|---|---|---|---|---|
| | | | Flow | On Time | Time |
| RUN | Reactor | Injector | Straightener | (hrs) | (hrs) |
| 1 | 128 | TB-8 h 19 mm, | No | 116.9 | 49.2 |
| | | RI-16 mm | | | |
| 2 | 128 | TB-8 h 19 mm, | No | 113.1 | 24.8 |
| | | RI-12.7 mm | | | |
| 3 | 129 | RI-12.77 mm/9.5 | No | 136.4 | 56.2 |
| | | mm | | | |
| 4 | 130 | TB-8 h 19 mm | No | 158.4 | 67.5 |
| 5 | 131 | TB-8 h 19 mm | No | 44.7 | 17.7 |
| 6 | 131 | TB-8 h 19 mm, | No | 138.8 | 51.3 |
| | | TB-8 h 27 mm | | | |
| 7 | 132 | TB-8-27 | No | 145.6 | 26.0 |
| 8 | 132 | TB-27-8\|TB-29- | No | 166.0 | 111.6 |
| | | 8\|TB-19-4 | | | |
| 9 | 133 | TB-27-8 | No | 40.9 | 7.7 |
| 10 | 134 | TB-19-8 | No | 105.5 | 25.3 |

TABLE 1B
Flow Straightener: Example reactor configurations
and injection hours per run.

| | | | | Torch | Injection |
|---|---|---|---|---|---|
| | | | Flow | On Time | Time |
| RUN | Reactor | Injector | Straightener | (hrs) | (hrs) |
| 11 | 139 | TB-38-15 | Yes | 136.0 | 100.1 |
| 12 | 140 | TB-38-15 | Yes | 126.8 | 95.3 |
| 13 | 141 | TB-38-15, K + | Yes | 111.9 | 70.3 |
| | | Rad | | | |
| 14 | 142 | TB-38-15 | Yes | 118.0 | 86.5 |
| 15 | 143 | TB-38-15 | Yes | 128.1 | 82.3 |
| 16 | 144 | TB-38-15 | Yes | 131.9 | 105.1 |
| 17 | 145 | TB-38-15, 3-4, | Yes | 124.6 | 90.0 |
| | | 2-3 | | | |
| 18 | 145 | TB-38-15, RI- | Yes | 86.9 | 57.2 |
| | | 13 mm | | | |
| 19 | 146 | TB-38-15/2-3 | Yes | 106.0 | 77.0 |
| 20 | 146 | TB-38-15, TB- | Yes | 116.1 | 85.5 |
| | | 38-2-3, TB-38- | | | |
| | | 1-1 | | | |
| 21 | 146 | TB-38-15 (Cu | Yes | 134.2 | 101.1 |
| | | and SS) | | | |

Reactor fouling data may be collected from three different reactor sections including the reactor top, reactor mid (middle), and reactor lower regions. The reactor top region may be the area closest to the feedstock injector. The reactor lower region may be an area disposed away from the feedstock injector. The reactor middle region may be an area disposed between the top region and the lower region. In the example, each reactor region may be or comprise a cylinder of approximately 2 meters in height with an interior diameter of approximately 1200 millimeters.

Tables 2A and 2B show percent of injected feedstock found as a solid carbon fouling deposit in each reactor region, and total fouling mass percentage. “Total Reactor Fouling” represents the mass of carbon collected from the internal reaction chamber wall after a run divided by the total mass of carbon injected into the system during the run. “Reactor Fouling Percentage (Deposit %)” represents the total mass of non-product carbon recovered from the system inclusive of the reactor walls, piping, and settling zones, after a run, divided by the total mass of carbon injected into the system during the run. In this example, a reactor without a flow straightening device may have a total reactor fouling of greater than 2500 on average. In this example, a comparative reactor comprising a flow straightening device may have a total reactor fouling of less than 3% (e.g., 2%) on average. As shown in Table 2B, the largest reduction in fouling percentage may occur at the reactor top or near-field fouling zone.

TABLE 2A
Base Case: Percentage of feedstock converted to fouling.

| | | | | | | Reactor |
|---|---|---|---|---|---|---|
| | | | | | Total | Fouling |
| | Flow | Reactor | Reactor | Reactor | Reactor | Percentage |
| RUN | Straightener | Top | Mid | Low | Fouling | (Deposit %) |
| 1 | No | 10.0% | 1.4% | 0.9% | 12.3% | 34.4% |
| 2 | No | 13.1% | 1.9% | 0.7% | 15.8% | 38.3% |
| 3 | No | 24.7% | 0.3% | 0.2% | 25.2% | 53.3% |
| 4 | No | 19.6% | 3.9% | 6.3% | 29.7% | 49.3% |
| 5 | No | 5.8% | 6.2% | 8.9% | 20.9% | 102.0% |
| 6 | No | 46.0% | 8.4% | 5.1% | 59.5% | 76.3% |
| 7 | No | 19.8% | 3.8% | 2.2% | 25.8% | 36.9% |
| 8 | No | 17.2% | 10.2% | 7.8% | 35.2% | 55.8% |
| 9 | No | 7.7% | 1.4% | 3.4% | 12.4% | 28.6% |
| 10 | No | 26.5% | 1.5% | 1.1% | 29.1% | 68.4% |

TABLE 2B
Flow Straightener: Percentage of feedstock converted to fouling.

| | | | | | | Reactor |
|---|---|---|---|---|---|---|
| | | | | | Total | Fouling |
| | Flow | Reactor | Reactor | Reactor | Reactor | Percentage |
| RUN | Straightener | Top | Mid | Low | Fouling | (Deposit %) |
| 11 | Yes | 0.2% | 0.3% | 0.9% | 1.5% | 5.8% |
| 12 | Yes | 0.2% | 0.3% | 0.4% | 0.9% | 4.2% |
| 13 | Yes | 0.5% | 0.3% | 0.5% | 1.2% | 4.8% |
| 14 | Yes | 1.0% | 0.3% | 1.4% | 2.6% | 7.1% |
| 15 | Yes | 0.5% | 0.6% | 1.0% | 2.1% | 9.0% |
| 16 | Yes | 0.8% | 0.5% | 0.9% | 2.1% | 6.8% |
| 17 | Yes | 0.6% | 0.8% | 1.0% | 2.4% | 8.3% |
| 18 | Yes | 0.6% | 0.8% | 1.5% | 2.9% | 12.8% |
| 19 | Yes | 0.7% | 0.8% | 0.9% | 2.4% | 15.1% |
| 20 | Yes | 0.5% | 0.6% | 0.8% | 1.9% | 8.9% |
| 21 | Yes | 0.5% | 0.8% | 0.6% | 1.8% | 11.5% |

While various embodiments of the present disclosure have been shown and described herein, those skilled in the art will understand that such embodiments are provided by way of example only. It is not intended that the present disclosure be limited by the specific embodiments, examples, or descriptions and illustrations of the embodiments provided within the specification. Numerous variations, changes, and substitutions may occur to those skilled in the art without departing from the present disclosure. It should be understood that various alternatives to the embodiments described herein may be employed and that all aspects of the present disclosure are not limited to the specific depictions, configurations, or relative proportions set forth herein which depend upon a variety of conditions and variables. It should be understood that various alternatives to the embodiments described herein may be employed in practicing the systems and methods of the present disclosure, without departing from the disclosure. It is therefore contemplated that the present disclosure shall also cover any such alternatives, modifications, variations or equivalents. It is intended that the following claims define the scope of the invention and that systems and methods within the scope of these claims and their equivalents be covered thereby.

1. An apparatus for making carbon particles, the apparatus comprising:
a plasma generating section;
a carbon particle generating section; and
an obstacle disposed between the plasma generating section and the carbon particle generating section, wherein the obstacle is configured to contact, during use, a thermal transfer gas flowing from the plasma generating section to the carbon particle generating section, thereby reducing an angular momentum of the fluid.

2. The apparatus of claim 1, wherein the plasma generating section comprises a plasma generating electrode.

3. The apparatus of claim 2, wherein the plasma generating electrode is configured to heat the thermal transfer gas in the plasma generating section.

4. The apparatus of claim 1, wherein the carbon particle generating section comprises a hydrocarbon injector configured to inject a hydrocarbon feedstock into the carbon particle generating section.

5. (canceled)

6. The apparatus of claim 1, wherein the obstacle is configured to be static when contacting the thermal transfer gas.

7. The apparatus of claim 1, further comprising a throat section disposed between the plasma generating section and the carbon particle generating section, wherein the throat section is narrower than the plasma generating section or the carbon particle generating section.

8. (canceled)

9. The apparatus of claim 7, wherein the obstacle is disposed in the throat section or at an entrance or an exit of the throat section.

10. (canceled)

11. The apparatus of claim 1, wherein the obstacle comprises a flat surface, a curved surface or a plate.

12. (canceled)

13. (canceled)

14. The apparatus of claim 1, wherein a surface of the obstacle is positioned perpendicular to a flow path of the fluid.

15. The apparatus of claim 1, wherein the obstacle comprises a plurality of members.

16. The apparatus of claim 15, wherein a first member of the plurality of members contacts a second member of the plurality of members.

17. The apparatus of claim 16, wherein the first member contacts the second member at a center axis of the apparatus.

18. The apparatus of claim 15, wherein two or more members of the plurality of members intersect or interlock with one another.

19. (canceled)

20. (canceled)

21. The apparatus of claim 15, wherein the members of the plurality of members are radially positioned with respect to one another.

22. (canceled)

23. (canceled)

24. (canceled)

25. The apparatus of claim 1, wherein the obstacle is configured to reduce bulk flow momentum of the thermal transfer gas flowing from the plasma generating section to the carbon particle generating section.

26.-40. (canceled)

41. The apparatus of claim 1, wherein the obstacle reduces the angular momentum of the thermal transfer gas by at least about 50%.

42. (canceled)

43. The apparatus of claim 1, wherein a ratio of angular momentum of the thermal transfer gas to linear momentum of the thermal transfer gas is less than about 1.5 prior to the thermal transfer gas entering the carbon particle generating section.

44. (canceled)

45. (canceled)

46. The apparatus of claim 4, wherein less than about 25% of the hydrocarbon feedstock fouls the carbon particle generating section.

47. (canceled)

48. The apparatus of claim 4, wherein less than about 10% of the hydrocarbon feedstock fouls the carbon particle generating section.

49.-81. (canceled)

82. The apparatus of claim 15, wherein the plurality of members comprises from two to twelve plates.
